(19) United States
(12) Patent Application Publication
(10) Pub. No.: US 2019/0171993 A1
(43) Pub. Date: Jun. 6, 2019

(54) COMPETENCY MANAGEMENT SYSTEM

(71) Applicants: Malcolm Edward Duncan, Houston, TX (US); Christopher James Iveson, Greasby (GB)

(72) Inventors: Malcolm Edward Duncan, Houston, TX (US); Christopher James Iveson, Greasby (GB)

(21) Appl. No.: 16/271,397

(22) Filed: Feb. 8, 2019

Related U.S. Application Data
(63) Continuation of application No. 15/922,199, filed on Mar. 15, 2018.
(60) Provisional application No. 62/505,824, filed on May 12, 2017.
(60) Provisional application No. 62/471,685, filed on Mar. 15, 2017.

(51) Int. Cl. G06Q 10/06; G06Q 50/00; G06T 19/00; G06Q 10/10

(52) U.S. Cl. CPC G06Q 10/06398; G06Q 10/105; G06T 19/006; G06Q 50/01

(57) ABSTRACT

Various implementations directed to a competency management system are provided. In one implementation, a method for performing an assessment using a competency management system may include displaying a skills map for a position within an organization, where the skills map corresponds to a skill represented by skill units, and where each skill unit includes skill elements having evidence requirements and competency levels. The method may also include receiving self-assessment data corresponding to the evidence requirements. The method may further include determining a self-assessment competency score based on the self-assessment data. The method may additionally include receiving supervisor assessment data from a supervisor of the organization, where the supervisor assessment data includes data indicating a confirmation or denial of the self-assessment competency score based on the evidence requirements. The method may also include determining a supervisor assessment competency score based on the supervisor assessment data.

### CROSS-REFERENCE TO RELATED APPLICATIONS

This application is a continuation of U.S. non-provisional application Ser. No. 15/922,199, filed Mar. 15, 2018, which claims the benefit of U.S. provisional patent application Ser. No. 62/471,685, filed Mar. 15, 2017 and of U.S. provisional patent application Ser. No. 62/505,824, filed May 12, 2017, the entire disclosures of each of which are incorporated herein by reference.

### BACKGROUND

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

Organizations of all sizes have a need to better understand and manage the competencies and capabilities of their people. Individual and organizational competencies may be used for business strategy and execution. A competent workforce may enable an organization to efficiently deliver sustainable business results. Effective competency management solutions may use a systematic process supported by a user-friendly competency management tool. However, some competency management solutions may be subject to limited functionality.

### SUMMARY

Described herein are implementations of various technologies relating to a competency management system. In one implementation, a method for generating a competency management framework for an organization using a competency management system may include receiving organizational data for the organization, where the organizational data includes data identifying one or more members of the organization and one or more positions within organization. The method may also include receiving skills data for the organization, where the skills data includes data regarding one or more skills required for the one or more positions, and where the one or more skills includes one or more skill elements. The method may further include receiving one or more predetermined narrative answers that correspond to the one or more skill elements, where the one or more predetermined narrative answers are configured to be compared to one or more narrative answers for the one or more skill elements during a competency assessment. The method may additionally include generating a skills library based on the skills data and the one or more predetermined narrative answers. The method may also include receiving associations between the one or more skills and the one or more positions. The method may further include generating one or more skills maps for the one or more positions based on the associations.

The skills may be categorized into one or more skill units, the one or more skill units may be subcategorized into the one or more skill elements, and the one or more skill elements may be organized based on one or more competency levels. The method may further include receiving training data, where the training data includes a list of training and development options to be used by the one or more members in order to become competent with respect to the one or more skills.

In another implementation, a method for generating a competency management framework for an organization using a competency management system may include receiving organizational data for the organization, where the organizational data includes data identifying one or more members of the organization and one or more positions within organization. The method may also include receiving skills data for the organization, where the skills data includes data regarding one or more skills required for the one or more positions, and where the one or more skills includes one or more skill elements. The method may further include receiving weighting data for the one or more skill elements, where the weighting data includes one or more numerical values to be assigned to the one or more skill elements. The method may additionally include generating a skills library based on the skills data and the weighting data, where generating the skills library includes assigning the one or more numerical values to the one or more skill elements. The method may also include receiving associations between the one or more skills and the one or more positions. The method may further include generating one or more skills maps for the one or more positions based on the associations.

In addition, assigning the one or more numerical values to the one or more skill elements may include assigning a numerical value to a respective skill element for a respective competency level. Further, the one or more skills may be categorized into one or more skill units, the one or more skill units may be subcategorized into one or more skill elements, and the one or more skill elements may be organized based on one or more competency levels. Additionally, assigning the one or more numerical values to the one or more skill elements may include assigning an equal numerical value to each skill element of a first skill unit of the one or more skill units. In addition, assigning the one or more numerical values to the one or more skill elements may include assigning a different numerical value to each skill element of a first skill unit of the one or more skill units. The method may also include receiving a minimum competency score for each skill unit.

In yet another implementation, a method for generating a competency management framework for an organization using a competency management system may include receiving organizational data for the organization, where the organizational data includes data identifying one or more members of the organization and one or more positions within organization. The method may also include receiving skills data for the organization, where the skills data includes data regarding one or more skills required for the one or more positions, and where the one or more skills includes one or more skill elements. The method may further include receiving evidence requirements data for the one or more skill elements, where the evidence requirements data indicate that the one or more organizational members are to provide one or more augmented reality simulations during a competency assessment, and where the one or more augmented reality simulations are configured to be recorded using an augmented reality device. The method may additionally include generating a skills library based on the skills data and the evidence requirements data. The method may also include receiving associations between the one or more skills and the one or more positions. The method may further include generating one or more skills maps for the one or more positions based on the associations.

In another implementation, a method for performing an assessment using a competency management system may include displaying a skills map for a position within an organization, where the skills map corresponds to at least one skill represented by one or more skill units, and where each skill unit includes one or more skill elements having one or more evidence requirements and one or more competency levels. The method may also include receiving self-assessment data corresponding to the one or more evidence requirements, where the self-assessment data includes one or more narrative answers. The method may further include determining a self-assessment competency score based on the self-assessment data. The method may additionally include receiving supervisor assessment data from a supervisor of the organization, where the supervisor assessment data includes data indicating a confirmation or denial of the self-assessment competency score based on a comparison of the one or more narrative answers to one or more predetermined narrative answers. The method may also include determining a supervisor assessment competency score based on the supervisor assessment data.

The method may further include determining one or more training options if the supervisor assessment competency score is less than a target competency score. The method may additionally include transmitting the self-assessment data, the supervisor assessment data, and the skills map to a verifier if the supervisor assessment competency score is greater than or equal to a target competency score for a predetermined competency level; receiving verifier assessment data from the verifier, where the verifier assessment data includes data indicating a confirmation of the supervisor assessment competency score based on a review of the self-assessment data and the supervisor assessment data; and based on the verifier assessment data, designating the supervisor assessment competency score as a final competency score. In addition, the displayed skills map may include one or more hyperlinks used to display the at least one skill, the one or more skill units, the one or more skill elements, the one or more evidence requirements, and the one or more competency levels. The one or more skill elements may describe tasks to be performed or information to be provided in order to demonstrate the one or more competency levels for the at least one skill. The one or more narratives answers may include definitions of terms, a listing of factors, identification of issues, discussions of topics, or combinations thereof. The self-assessment competency score and the supervisor assessment competency score may be determined based on weighting data for the one or more skill elements.

In yet another implementation, a method for performing an assessment using a competency management system may include displaying a skills map for a position within an organization, where the skills map corresponds to at least one skill represented by one or more skill units, and where each skill unit includes one or more skill elements having one or more evidence requirements and one or more competency levels. The method may also include receiving self-assessment data for the one or more skill elements, where the self-assessment data may include evidence corresponding to one or more evidence requirements of the one or more skill elements. The method may further include determining a self-assessment competency score based on the self-assessment data and on weighting data for the one or more skill elements. The method may additionally include receiving supervisor assessment data from a supervisor of the organization, where the supervisor assessment data includes data indicating a confirmation or denial of the self-assessment competency score based on a review of the self-assessment data. The method may also include determining a supervisor assessment competency score based on the supervisor assessment data and on the weighting data for the one or more skill elements.

In addition, the weighting data may include one or more numerical values assigned to the one or more skill elements. Further, the one or more skill units may include a first skill unit having a first skill element and a second skill element associated with a first competency level; and the first skill element may be assigned a first numerical value and the second skill element is assigned a second numerical value, where the first numerical value and the second numerical value are different.

In another implementation, a method for performing an assessment using a competency management system may include displaying a skills map for a position within an organization, where the skills map corresponds to at least one skill represented by one or more skill units, and where each skill unit includes one or more skill elements having one or more evidence requirements and one or more competency levels. The method may also include receiving self-assessment data corresponding to the one or more evidence requirements of the one or more skill elements, where the self-assessment data includes one or more augmented reality simulations recorded using the competency management system and an augmented reality device. The method may further include determining a self-assessment competency score based on the self-assessment data. The method may additionally include receiving supervisor assessment data from a supervisor of the organization, where the supervisor assessment data includes data indicating a confirmation or denial of the self-assessment competency score based on a review of the one or more augmented reality simulations. The method may also include determining a supervisor assessment competency score based on the supervisor assessment data.

In yet another implementation, a method for performing an assessment using a competency management system may include displaying a skills map for a position within an organization, where the skills map corresponds to at least one skill represented by one or more skill units, and where each skill unit includes one or more skill elements having one or more evidence requirements and one or more competency levels. The method may also include receiving self-assessment data for the one or more skill elements, where the self-assessment data includes evidence corresponding to one or more evidence requirements of the one or more skill elements. The method may further include determining a self-assessment competency score based on the self-assessment data. The method may additionally include determining if a first supervisor of the organization has demonstrated the one or more competency levels for the one or more skill elements. The method may also include delegating a supervisor assessment to a second supervisor or subject matter expert of the organization if the first supervisor has not demonstrated the one or more competency levels for the one or more skill elements. The method may further include receiving supervisor assessment data from the second supervisor or subject matter expert for the supervisor assessment, where the supervisor assessment data includes data indicating a confirmation or denial of the self-assessment competency score based on a review of the self-assessment data. The method may also include determining a supervisor assessment competency score based on the supervisor assessment data.

In addition, the second supervisor may have previously demonstrated the one or more competency levels for the one or more skill elements. Delegating the supervisor assessment may include delegating the supervisor assessment based on a forced delegation by the competency management system. Delegating the supervisor assessment may include delegating the supervisor assessment based on a voluntary delegation by the first supervisor.

In another implementation, a method for performing a history module of a competency management system may include displaying a skills map for a position within an organization to a user, where the skills map corresponds to one or more skills represented by one or more skill units, and where each skill unit includes one or more skill elements having one or more evidence requirements and one or more competency levels. The method may also include receiving self-assessment data from a user, where the self-assessment data includes evidence corresponding to one or more evidence requirements of the one or more skill elements. The method may further include determining a self-assessment competency score for the user based on the self-assessment data. The method may additionally include receiving supervisor assessment data from a supervisor of the organization, where the supervisor assessment data includes data indicating a confirmation or denial of the self-assessment competency score for the user based on a review of the self-assessment data. The method may also include recording history data for the self-assessment data and the supervisor assessment data, where the history data includes data representing a date, time, or combinations thereof for when the self-assessment data and the supervisor assessment data are received. The method may further include displaying the history data.

In addition, recording the history data may include recording the history data in real time.

In one implementation, a method for performing a risk analysis module of a competency management system may include receiving organizational data for the organization, where the organizational data includes data identifying one or more members for a unit of the organization. The method may also include receiving one or more assessment competency scores for the one or more members with respect to one or more skills used within the organization, where the one or more assessment competency scores are determined based on assessment data for the one or more members, and where the assessment data corresponds to one or more skill elements of the one or more skills. The method may further include receiving risk data with respect to the one or more skills for the unit of the organization, where the risk data includes one or more risk levels, one or more color coding options, and one or more development needs associated with one or more ranges of competency scores, and where the risk data is predetermined. The method may also include generating a risk matrix based on the organizational data, the one or more assessment competency scores, and the risk data. The method may further include displaying the risk matrix.

In addition, the one or more assessment competency scores may include one or more supervisor assessment competency scores and the assessment data includes supervisor assessment data. The one or more assessment competency scores may be determined by displaying a skills map for a position within the organization to the one or more members, where the skills map corresponds to the one or more skills represented by the one or more skill elements, and where the one or more skill elements include one or more evidence requirements and one or more competency levels; receiving self-assessment data for the one or more skill elements from the one or more members, where the self-assessment data includes evidence corresponding to one or more evidence requirements of the one or more skill elements; determining one or more self-assessment competency scores for the one or more skills for the one or more members based on the self-assessment data; receiving the supervisor assessment data from a supervisor of the organization for the one or more members, where the supervisor assessment data includes data indicating confirmations or denials of the self-assessment competency scores for the members based on a review of the self-assessment data; and determining the one or more supervisor assessment competency scores for the one or more skills based on the supervisor assessment data for the one or more skill elements for the one or more members.

In another implementation, a method for performing a staffing module of a competency management system may include receiving organizational data for the organization, where the organizational data includes data identifying one or more members of the organization and data regarding one or more termination dates for the one or more members. The method may also include receiving one or more assessment competency scores for the one or more members with respect to one or more skills used within the organization, where the one or more assessment competency scores are determined based on assessment data for the one or more members, and where the assessment data corresponds to one or more skill elements of the one or more skills. The method may further include identifying one or more competency gaps for the one or more skills in the assessment data, where the competency gaps represent the assessment competency scores that are less than a respective targeted competency score. The method may additionally include identifying one or more candidates having assessment competency scores that are greater than or equal to the respective targeted competency score.

In addition, the competency gaps may be tied to the one or more termination dates. The one or more assessment competency scores may include one or more supervisor assessment competency scores and the assessment data may include supervisor assessment data. The one or more assessment competency scores may be determined by displaying a skills map for a position within the organization to the one or more members, where the skills map includes a skill having one or more skill units, and where each skill unit includes one or more skill elements having one or more evidence requirements and one or more competency levels; receiving self-assessment data for the one or more skill elements for the one or more members, where the self-assessment data includes evidence corresponding to one or more evidence requirements of the one or more skill elements; determining one or more self-assessment competency scores for the skill for the one or more members based on the self-assessment data; receiving the supervisor assessment data from a supervisor of the organization for the one or more members, where the supervisor assessment data includes data indicating confirmations or denials of the self-assessment competency scores for the members based on a review of the self-assessment data; and determining the one or more supervisor assessment competency scores for the one or more skills based on the supervisor assessment data for the one or more skill elements for the one or more members.

In yet another implementation, a method for performing a pre-assessment module of a competency management system may include generating a pre-assessment skills map for a position within an organization, where the pre-assessment skills map corresponds to at least one skill represented by one or more skill units, and where each skill unit includes one or more skill elements having one or more evidence requirements. The method may also include transmitting the pre-assessment skill map to one or more candidates. The method may further include receiving candidate self-assessment data corresponding to the one or more evidence requirements of the one or more skill elements. The method may additionally include receiving hiring assessment data from a supervisor of the organization, where the hiring assessment data includes data indicating a confirmation or denial that the one or more candidates is competent with respect to the one or more skill elements. The method may also include determining a candidate assessment competency score based on the hiring assessment data.

In addition, the candidate self-assessment data may include one or more narrative answers, and the hiring assessment data may be based on a comparison of the one or more narrative answers to one or more predetermined narrative answers.

In one implementation, a method for performing a knowledge module of a competency management system may include identifying one or more members of an organization having a competency score for a skill used by the one or more members, where the competency score is greater than or equal to a maximum competency score for the skill, and where the competency score had been determined after a verifier assessment. The method may also include organizing the one or more members into a subject matter expert group. The method may further include receiving one or more questions from other members of the organization regarding the skill. The method may additionally include receiving one or more answers from the subject matter expert group. The method may also include providing the one or more answers to the other members of the organization.

In addition, the verifier assessment may be performed by receiving self-assessment data corresponding to one or more evidence requirements of the one or more skill elements of the skill for the plurality of competency levels, where the self-assessment data includes one or more narrative answers; determining a self-assessment competency score based on the self-assessment data; receiving supervisor assessment data from a supervisor of the organization, where the supervisor assessment data includes data indicating a confirmation or denial of the self-assessment competency score based on a comparison of the one or more narrative answers to one or more predetermined narrative answers; determining a supervisor assessment competency score based on the supervisor assessment data; transmitting the self-assessment data, the supervisor assessment data, and the skills map to a verifier if the supervisor assessment competency score is greater than or equal to a minimum competency score; receiving verifier assessment data from the verifier, where the verifier assessment data includes data indicating a confirmation or denial of the supervisor assessment competency score based on a review of the self-assessment data and the supervisor assessment data; and based on the verifier assessment data, designating the supervisor assessment competency score as the final competency score.

In another implementation, a method for performing an exposure levels module of a competency management system may include assigning one or more training options corresponding to a plurality of skills to a member of an organization, where the training options are prioritized based on a competency assessment of the member with respect to the plurality of skills. The method may also include receiving exposure level data regarding a first skill of the plurality of skills for the member, where the exposure level data may include data indicating a level of frequency at which the member is currently exposed to the first skill. The method may further include prioritizing the one or more training options corresponding to the plurality of skills for the member based on the exposure level data, where a first training option of the one or more training options that corresponds to the first skill is given a higher priority as the level of frequency increases.

In addition, the one or more training options may include learning references, classroom courses, books, manuals, policies, procedures, online references, recommendations for on the job training, online learning, or combinations thereof. The level of frequency may be measured daily, weekly, monthly or annually. The competency assessment may include a supervisor assessment. Assigning the one or more training options may include receiving self-assessment data for one or more skill elements of the plurality of skills, where the self-assessment data includes evidence corresponding to one or more evidence requirements of the one or more skill elements; determining one or more self-assessment competency scores based on the self-assessment data; as part of the supervisor assessment, receiving supervisor assessment data from a supervisor of the organization, where the supervisor assessment data includes data indicating a confirmation or denial of the one or more self-assessment competency scores based on a review of the self-assessment data; determining one or more supervisor assessment competency scores based on the supervisor assessment data; and assigning the one or more training options corresponding to the plurality of skills if the one or more supervisor assessment competency scores is less than a targeted competency score.

In yet another implementation, a method for performing a report authentication module of a competency management system may include receiving assessment data corresponding to one or more skills for one or more members of an organization. The method may also include receiving a request to generate a report based on the assessment data, where the report includes a summary of the assessment data. The method may further include generating a Quick Response (QR) code for the report. The method may additionally include generating the report with the QR code displayed therein.

In one implementation, a method for performing a member authentication module of a competency management system may include receiving organizational data for the organization, where the organizational data includes data identifying one or more members of the organization. The method may also include receiving assessment data corresponding to one or more skills for the one or more members with respect to one or more competency levels. The method may further include generating one or more Quick Response (QR) codes for the one or more members. The method may additionally include assigning the one or more QR codes to the one or more members.

In addition, the QR codes may be configured to provide access to reports on the assessment data associated with the one or more members, member profiles associated with the one or more members, or combinations thereof, via scanning of the QR codes. The assessment data may include self-assessment data, a self-assessment competency score, supervisor assessment data, a supervisor assessment competency score, and/or verifier assessment data corresponding to the one or more skills for the one or more members. Receiving the assessment data may include receiving the self-assessment data for one or more skill elements of the one or more skills, where the self-assessment data may include evidence corresponding to one or more evidence requirements of the one or more skill elements for one or more competency levels; determining the self-assessment competency score based on the self-assessment data; receiving the supervisor assessment data from a supervisor of the organization, where the supervisor assessment data includes data indicating a confirmation or denial of the self-assessment competency score based on the one or more evidence requirements; determining the supervisor assessment competency score based on the supervisor assessment data; transmitting the self-assessment data and the supervisor assessment data to a verifier if the supervisor assessment competency score is greater than or equal to a targeted competency score; receiving the verifier assessment data from the verifier, where the verifier assessment data may include data indicating a confirmation or denial of the supervisor assessment competency score based on a review of the self-assessment data and the supervisor assessment data; and based on the verifier assessment data, designating the supervisor assessment competency score as the final competency score.

In another implementation, a method for performing a social media module for a competency management system may include identifying a member of an organization having a competency score for a skill used by the member that corresponds to a competency level of a plurality of competency levels, where the final competency score is greater than or equal to a predetermined competency score. The method may also include accessing a social media account using a network. The method may further include communicating an endorsement of the member with respect to the skill using the social media account.

In yet another implementation, a method for performing an equipment module of a competency management system may include receiving organizational data for the organization, where the organizational data includes data identifying one or more members of the organization. The method may also include receiving equipment data for the one or more members, where the equipment data includes data relating to one or more pieces of equipment assigned to the one or more members and data relating to one or more expiration dates for the one or more pieces of equipment. The method may further include tracking the one or more expiration dates of the one or more pieces of equipment for the one or more organizational members based on the equipment data. The method may additionally include ordering one or more pieces of new equipment based on the one or more expiration dates.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Implementations of various techniques will hereafter be described with reference to the accompanying drawings. It should be understood, however, that the accompanying drawings illustrate only the various implementations described herein and are not meant to limit the scope of various techniques described herein.

FIG. 1 illustrates a schematic diagram of a computing system which implements a competency management system (CMS) in accordance with implementations of various techniques described herein.

FIG. 2 illustrates a schematic diagram of software modules organized by stages in accordance with implementations of various techniques described herein.

FIG. 3 illustrates a pictorial representation of skills within a skills library in accordance with implementations of various techniques described herein.

FIG. 4 illustrates an example of a skills library in accordance with implementations of various techniques described herein.

FIG. 5 illustrates an example of a skill element in accordance with implementations of various techniques described herein.

FIG. 6 illustrates a flow diagram of a method for generating a competency management framework for an organization in accordance with implementations of various techniques described herein.

FIG. 7 illustrates a flow diagram of a method for assessing a competency for an organizational member in accordance with implementations of various techniques described herein.

FIG. 8 illustrates a graphical representation of history data recorded by a History Module in accordance with implementations of various techniques described herein.

FIG. 9 illustrates a flow diagram of a method for tracking an assessment history for an organizational member in accordance with implementations of various techniques described herein.

FIG. 10 illustrates a graphical representation of a risk matrix for an organizational unit in accordance with implementations of various techniques described herein.

FIG. 11 illustrates a flow diagram of a method for generating a risk matrix for an organizational unit of an organization in accordance with implementations of various techniques described herein.

FIG. 12 illustrates a flow diagram of a method for staffing an organization in accordance with implementations of various techniques described herein.

FIG. 13 illustrates a flow diagram of a method for performing a pre-assessment of a candidate for an organization in accordance with implementations of various techniques described herein.

FIG. 14 illustrates a flow diagram of a method for using a subject matter expert (SME) group for an organization in accordance with implementations of various techniques described herein.

FIG. 15 illustrates a flow diagram of a method for prioritizing one or more training options for a skill based on an exposure level in accordance with implementations of various techniques described herein.

FIG. 16 illustrates a flow diagram of a method for authenticating a report from a CMS in accordance with implementations of various techniques described herein.

FIG. 17 illustrates a flow diagram of a method for assigning a Quick Response (QR) code to an organizational member in accordance with implementations of various techniques described herein.

FIG. 18 illustrates a flow diagram of a method for endorsing a skill via social media in accordance with implementations of various techniques described herein.

FIG. 19 illustrates a flow diagram of a method for managing equipment in accordance with implementations of various techniques described herein.

FIG. 20 illustrates a schematic diagram of a computing system in which the various technologies described herein may be incorporated and practiced.

### DETAILED DESCRIPTION

For an individual or a group, competency can represent a measurable and quantifiable depth of knowledge, skill set, and/or performance ability. In particular, competency can indicate an ability of an individual or group to perform effectively with respect to a specific position (e.g., a job) and/or circumstance. In general, a competency management system (CMS) is a system having one or more software applications and one or more databases that allow for the management of competencies of individuals and/or groups.

A CMS can be used by and tailored for an organization to assess, evaluate, and/or improve the competencies of organizational members, specific groups of the organizational members, and/or the organization as a whole. Any organization with employees may use a CMS to manage competencies, including, for example, oil & gas exploration companies, health care companies, governmental agencies, non-profit organizations, and so forth.

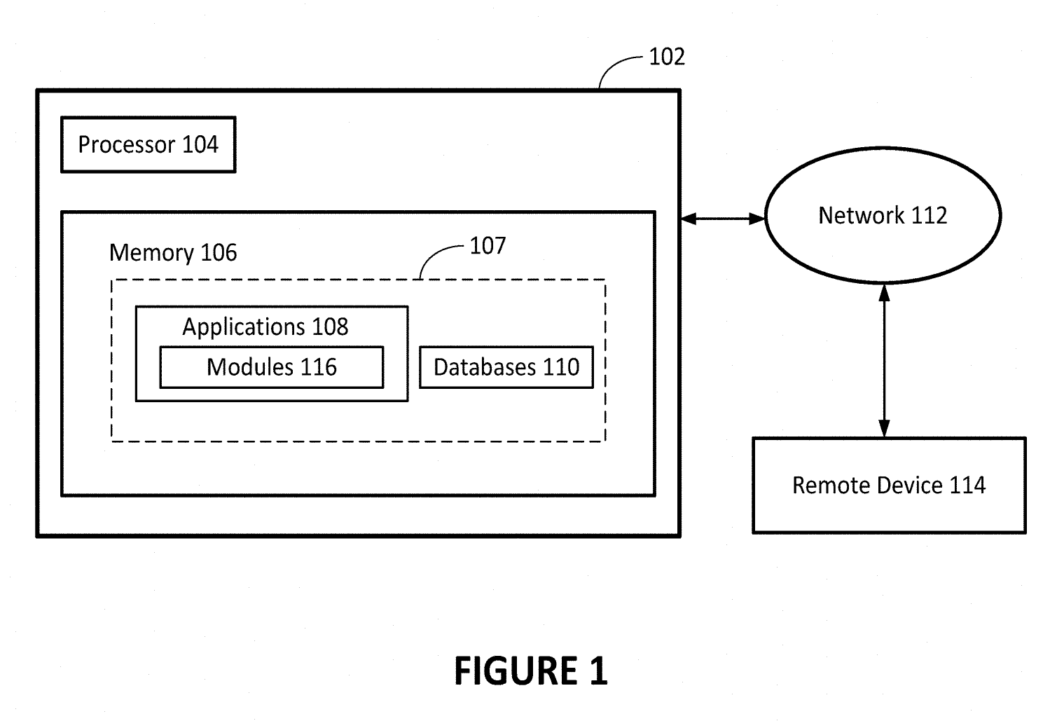

Various implementations described herein are directed to a competency management system (CMS). As will be described in more detail below, the CMS described herein includes one or more databases and one or more software applications composed of a plurality of software modules, where the software modules may be used to create and manage a competency management framework for a particular organization. The software modules may be generally organized into three stages for creating and managing the competency management framework: (i) a build stage, (ii) an assessment stage, and (iii) an analysis stage. The build stage modules are used to create the competency management framework for an organization. The assessment stage modules are used to assess current competencies of organizational members via the framework, verify these competencies, and improve competencies to desired levels based on a number of factors, where such improvement may be achieved via a development plan and/or performance objectives. The analysis stage modules are used to analyze real-time individual, team, and organizational competency information obtained during the assessment stage, such as by viewing the information through dashboards and/or reports. In this manner, the CMS may generate the competency management framework for an organization in the build stage, and then the CMS may be used in the assessment and analysis stages to manage individual, group, and organizational competencies. Various implementations of the CMS, including its plurality of software modules and one or more databases, and the operation of the CMS are further described below with reference to FIGS. 1-20.

### I. System

In one implementation, the CMS may be implemented using any computing system known to those skilled in the art, where the computing system may be a personal computer, a laptop computer, a smart device, a workstation, a network server, an augmented reality device, or the like. For example, FIG. 1 illustrates a schematic diagram of a computing system 102 which implements a CMS 107 in accordance with implementations of various techniques described herein. As shown, the computing system 102 may include a processor 104 and memory 106.

The processor 104 may be implemented as one or more microprocessors, microcomputers, central processing units (CPUs), and/or any similar device known to those in the art. The processor 104 may be configured to execute one or more program instructions stored in memory 106. The memory 106 may represent any computer-readable storage media known to those skilled in the art, including various forms of read-only memory (ROM), random-access memory (RAM), flash memories, hard disk drives, magnetic disk drives, optical drives, and/or the like.

As shown in FIG. 1, the CMS 107 may be stored in memory 106, where the CMS 107 may include one or more software applications 108 and one or more databases 110. Though not shown in FIG. 1, the computing system 102 may also use one or more other storage devices known in the art in order to implement the CMS 107, where such storage devices may include local storage devices, remote storage systems (e.g., remote database facilities), cloud computing storage systems, and/or the like. In a further implementation, one or more of the databases 110 of the CMS 107 may be stored using a remote storage system.

As also shown in FIG. 1, one or more remote devices 114 may be configured to communicate with the computing system 102 via the network 112 in order to access the CMS 107. As known in the art, the one or more remote devices 114 may be any computing device known to those skilled in the art, such as a personal computer, a laptop computer, a tablet device, a smart device, a workstation, an augmented reality device and/or the like. In particular, the remote devices 114 may be configured to establish a connection and communicate over the network 114 in order to carry out the various implementations of the CMS 107 described herein. The network 112 may represent any type of known network, including a wireless network, a mobile network, a wired network, a local area network (LAN), a wide area network (WAN), the internet, and/or the like. In particular, the network 112 may be used to exchange data between the remote devices 114 and the computing system 102, and may also be used to access data stored on the other storage devices (not pictured) mentioned above.

As such, in view of FIG. 1, a user may access the CMS 107 in a variety of ways. In one implementation, a user may have physical access to the computing system 102, and thus may use input/output devices (not shown) connected to the computing system 102 to interact with the CMS 107. In another implementation, a user may use a remote device 114 to remotely access the CMS 107 via the network 112, such as by logging into a webpage or web portal over the network 112 (e.g., the internet). The computing system 102, network 112, and remote devices 114 are described in further detail in a later section. In one implementation, the computing system 102 may be a cloud-based computing system.

As noted above, the CMS 107 may be stored in memory 106, where the CMS 107 may include one or more software applications 108 and one or more databases 110. The one or more software applications 108 may be composed of a plurality of software modules 116, where the software modules 116 may include routines, programs, objects, components, data structures, and so forth that perform particular tasks or implement particular data types. Specifically, the software modules 116 may be used to create and manage a competency management framework for a particular organization. In addition, the one or more databases 110 may be configured to store data that is processed, received, and/or generated by the software modules 116.

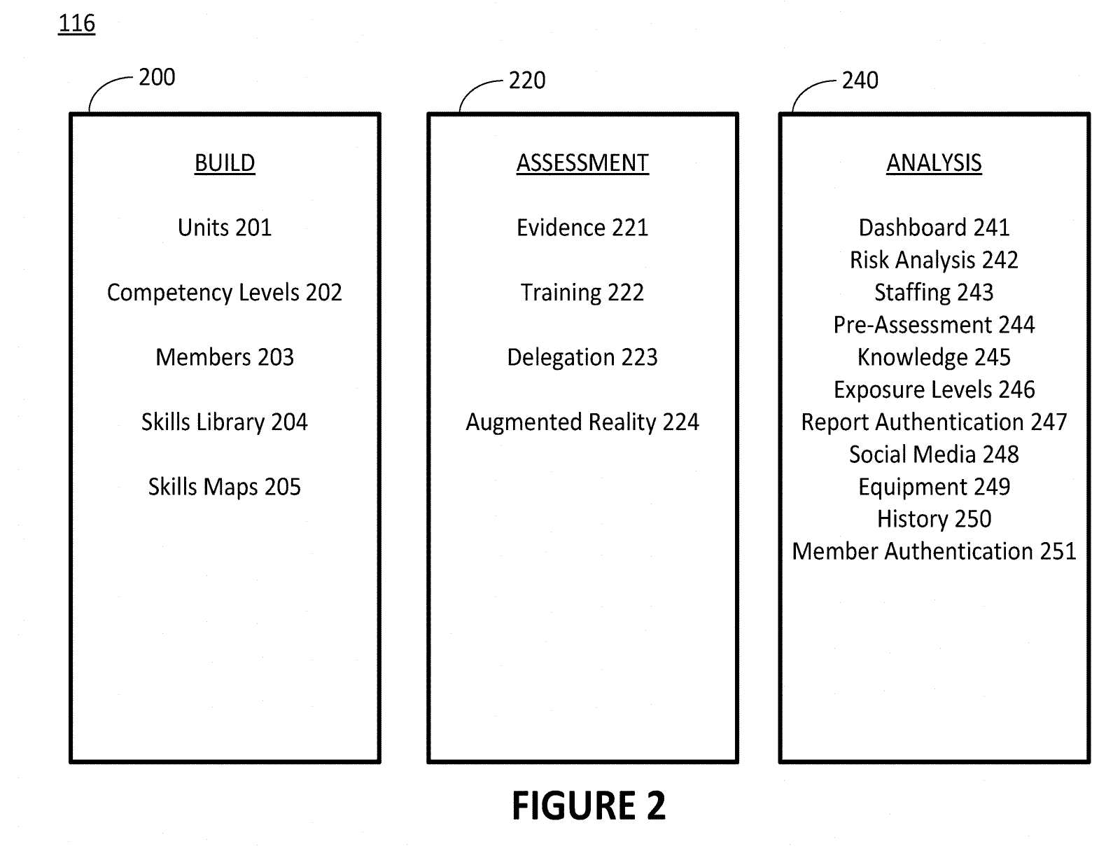

As briefly described above, the software modules 116 may be generally organized into three stages for creating and managing the competency management framework for an organization: (i) a build stage, (ii) an assessment stage, and (iii) an analysis stage. FIG. 2 illustrates a schematic diagram of the software modules 116 organized by stages in accordance with implementations of various techniques described herein. As shown, the plurality of software modules 116 may include build stage modules 200, assessment stage modules 220, and analysis stage modules 240.

The build stage modules 200 of the CMS 107 may be used to generate the competency management framework for an organization. Specifically, the build stage modules 200 may be used to generate a skills library and a skills maps database for the organization. In particular, the build stage modules 200 may include, at least, a Units Module 201, a Competency Levels Module 202, a Members Module 203, a Skills Library Module 204, and a Skills Maps Module 205. Though not shown in FIG. 2, other modules known to those skilled in the art may also be included in order to generate the competency management framework for an organization. These various modules described above will be described in further detail below.

The assessment stage modules 220 may be used to assess current competencies of organizational members via the competency management framework, verify these competencies, and improve competencies to desired levels based on a number of factors, where such improvement may be achieved via training. In particular, the assessment stage may include three phases: a member assessment, a supervisor assessment, and a verifier assessment. In addition, the assessment stage modules 220 may include, at least, an Evidence Module 221, a Training Module 222, a Delegation Module 223, and an Augmented Reality Module 224. Though not shown in FIG. 2, other modules known to those skilled in the art may also be included in order to assess, verify, and improve competencies for an organization. These various modules described above will be described in further detail below.

The analysis stage modules 240 may be used to analyze real-time individual, team, and organizational competency information obtained during the assessment stage. In particular, the analysis stage modules 240 may include, at least, a Dashboard Module 241, a Risk Analysis Module 242, a Staffing Module 243, a Pre-assessment Module 244, a Knowledge Module 245, an Exposure Levels Module 246, a Report Authentication Module 247, a Social Media Module 248, an Equipment Module 249, a History Module 250, and a Member Authentication Module 251. Though not shown in FIG. 2, other modules known to those skilled in the art may also be included in order to analyze competency information obtained during the assessment stage. These various modules described above will be described in further detail below.

### II. Operation

Various implementations of operating the CMS 107 are further described below. In particular, the CMS 107 can be used by and tailored for an organization to assess, evaluate, and/or improve the competencies of organizational members, specific groups of the organizational members, and/or the organization as a whole. While the following implementations may describe using the CMS 107 with respect to an oil & gas (O&G) exploration company, a person skilled in the art will understand that these implementations may also apply to other types of organizations.

### A. Build Stage Modules

As noted above, the build stage modules 200 of the CMS 107 may be used to generate a competency management framework for an organization. The competency management framework for an organization may be data that corresponds to the organization's structure, where the data may be stored in the databases 110 and organized in a manner such that organizational competencies can be assessed, managed, and analyzed. The competency management framework stored in the databases 110 can be accessed by the assessment stage modules 220 and analysis stage modules 240, as further described in later sections.

In one implementation, the competency management framework may include an organizational database, a skills library, and a skills maps database stored in the databases 110. As such, the build stage modules 200 may be used to build the organizational database, the skills library, and the skills maps database for an organization. Specifically, the organizational database, the skills library, and the skills maps database of the competency management framework may include data regarding organizational units, organizational members, hierarchy of the organizational members and/or the organizational units, job functions and/or titles of the organizational members, skills used within the organization, skills for particular positions and/or members, competency levels for particular positions and/or members, certification or compliance information for the skills, and/or the like.

In one implementation, the CMS 107 may receive the data for the competency management framework using the computing system 102 and/or the one or more remote devices 114. As an example, a user (e.g., an administrator) of the organization may log into a webpage or web portal using the network 112 (e.g., the internet) via a remote device 114 in order to provide the data for the competency management framework to one or more build stage modules 200 of the CMS 107, where the CMS 107 may store the data in the one or more databases 110.

### 1. Organizational Database

As mentioned above, the build stage modules 200 of the CMS 107 may be used to build an organizational database. In particular, the CMS 107 may receive data identifying organizational units, organizational members, hierarchy of organizational members and/or units, job functions and/or titles of the organizational members, and so forth. Such data may hereinafter be referred to as organizational data. The received organizational data may be stored in the organizational database, which may be stored in the one or more databases 110.

In particular, the organizational data may be arranged into a plurality of organizational units within the organizational database of the CMS 107. An organizational unit may represent a particular group of organizational members within the organization. As such, the organizational data provided to the CMS 107 may include numbers and/or names for the organizational units. For example, the organization may be a business, and the units may represent various divisions of the business. In such an example, the CMS 107 may receive organizational data that includes the names of each division of the business. Examples of business divisions include marketing, engineering, manufacturing, etc.

Further, the organizational data provided to the CMS 107 may also include a hierarchy of the organizational units. For example, the CMS 107 may receive organizational data that includes information regarding which division of a business oversees other divisions of the business.

In one implementation, a user (e.g., an administrator) of the organization may provide data regarding the organizational units and/or the hierarchy of the organizational units using the Units Module 201 of the CMS 107. In one implementation, the Units Module 201 may be used to view, add, edit, and/or delete organizational units and groups of organizational members, including the transfer of members between the units. The Units Module 201 may also be used to set an assessment hierarchy for organizational members to be used during the assessment stage, which will be further described in another section.

The organizational data may also include information regarding the organizational members, job functions and/or titles of the organizational members, and a hierarchy of the organizational members. In particular, the organizational data may include such information for each organizational unit of the organization. For example, for an O&G exploration company, the CMS 107 may receive a list of engineering positions associated with each business division of the company. The CMS 107 may also receive a list of engineers employed by the company, along with information regarding assigned engineering positions, assigned job titles, and/or assigned business divisions for each engineer. In addition, the CMS 107 may receive information regarding a hierarchy of the engineers employed by the company, particularly within each business division. This hierarchy may include information such as assigned supervisors for each engineer, which may be used for an assessment hierarchy during the assessment stage, as further described in another section.

In one implementation, a user (e.g., an administrator) of the organization may provide data regarding the organizational members, job functions and/or titles of the organizational members, and a hierarchy of the organizational members using the Members Module 203 of the CMS 107. In one implementation, the Members Module 203 may be used to view, add, edit, and/or delete organizational members, job functions and/or titles of the organizational members, and a hierarchy of the organizational members, and may also be used to assign skills maps to a member, remove skills from a skills map assigned to an organizational member or unit, and/or the like. The skills maps are further described in another section.

### 2. Skills Library

As mentioned above, the build stage modules 200 of the CMS 107 may be used to build a skills library. In particular, the CMS 107 may receive data identifying skills used within the organization, competency levels, and the like. Such data (hereinafter referred to as skills data) may include information regarding a plurality of skills used by organizational members. In one implementation, a skill may represent knowledge and/or an ability that enables an organizational member to perform effectively with respect to a specific position (e.g., a job) and/or circumstance for the organization. The skills data may be stored in the skills library, which may be stored within the databases 110.

The skills data received by the CMS 107 and stored in the skills library may include the names for each skill, along with information regarding one or more skill units, one or more skill elements, and one or more competency levels for each skill. In one implementation, a skill unit may represent a category or topic for a particular skill. Further, each skill unit may be composed of one or more skill elements. Each skill element may describe a task, information, and/or the like that an organizational member is to be capable of performing or providing in order to demonstrate a level of competency for a particular skill and/or skill unit.

As such, within the skills library, each skill may be categorized into one or more skill units, and each skill unit may be further subcategorized into one or more skill elements. Further, the one or more skill elements for a particular skill may be organized into one or more competency levels. A competency level may represent a mastery or proficiency level possessed by an organizational member with respect to a particular skill, skill unit, and/or skill element.

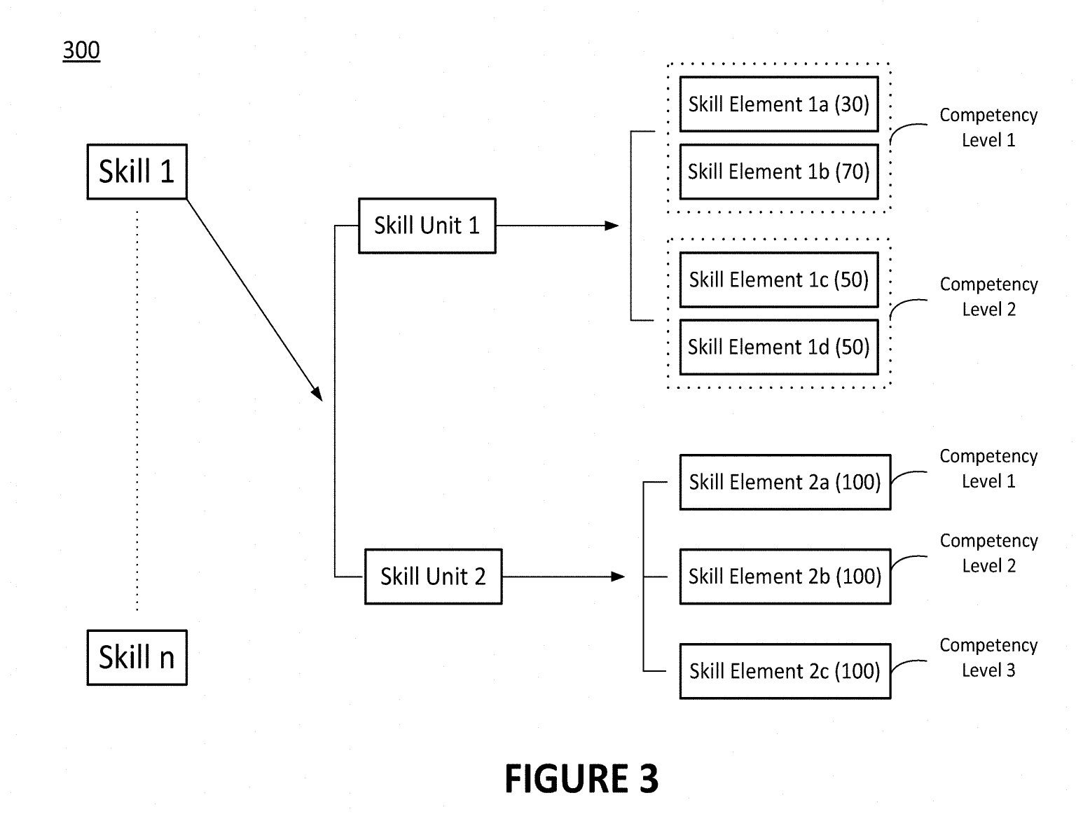

For example, FIG. 3 illustrates a pictorial representation of skills within the skills library 300 in accordance with implementations of various techniques described herein. As shown, the skills library 300 may include a plurality of skills, from Skill 1 to Skill n, where n may represent any integer greater than 1. As shown, Skill 1 may be categorized into Skill Unit 1 and Skill Unit 2. As is also shown, Skill Unit 1 may be subcategorized into Skill Element 1a, Skill Element 1b, Skill Element 1c, and Skill Element 1d. Skill Element 1a and Skill Element 1b may correspond to a Competency Level 1, and Skill Element 1c and Skill Element 1d may correspond to a Competency Level 2. In addition, Skill Unit 2 may be subcategorized into Skill Element 2a, Skill Element 2b, and Skill Element 2c. Skill Element 2a may correspond to the Competency Level 1, Skill Element 2b may correspond to the Competency Level 2, and Skill Element 2c may correspond to a Competency Level 3.

Each skill of a skills library can be configured to include any number of skill units, and each skill unit in the skills library can be configured to include any number of skill elements. Further, any number of competency levels may be utilized within the skills library.

The one or more competency levels may represent varying levels of mastery or proficiency possessed by an organizational member with respect to a particular skill, skill unit, and/or skill element. In one implementation, competency levels of higher numerical value may represent a more advanced mastery or proficiency level than competency levels of lower value. For example, in FIG. 3, the Competency Level 3 may represent a more advanced proficiency level than the Competency Level 2, and the Competency Level 2 may represent a more advanced proficiency level than the Competency Level 1.

In order to demonstrate a particular competency level for a skill, an organizational member may be required to complete the skill elements corresponding to that competency level for each skill unit of the skill. Completing the skill element may be defined as providing confirmation, such as through evidence, that the organizational member is capable of performing the task or providing the information described in the skill element. In one example, with respect to FIG. 3, in order to demonstrate a Competency Level 1 for Skill 1, an organizational member may need to complete the skill elements of Skill Units 1 and 2 that correspond to the Competency Level 1 (i.e., Skill Element 1a, Skill Element 1b, and Skill Element 2a).

In another implementation, the competency levels for a skill may be cumulative, where demonstration of a higher competency level for the skill requires a demonstration of all lower competency levels for that skill. For example, with respect to FIG. 3, to demonstrate a Competency Level 2 for Skill 1, an organizational member may need to complete the skill elements of Skill Units 1 and 2 that correspond to the Competency Levels 1 and 2 (i.e., Skill Element 1a, Skill Element 1b, Skill Element 1c, Skill Element 1d, Skill Element 2a, and Skill Element 2b).

In addition to the skills data described above, the CMS 107 may also receive weighting data for the skill elements of the skills library, where the weighting data may include numerical values to be assigned to the skill elements of the skills library. Such data may also be stored in the skills library within the one or more databases 110. In particular, for a particular competency level, the skill elements of a skill unit may each be weighted by numerical values, where the numerical values for each element at the particular competency level may be the same or different. In addition, for a particular competency level, the sum of the numerical values for the skill elements of each skill unit may be assigned a total numerical value (e.g., 100). After receiving the weighting data, the CMS 107 may assign the numerical values of the weighting data to the skill elements in the skills library.

For example, in FIG. 3, for Competency Level 1, the skill elements of Skill Unit 1 may each be weighted with different numerical values, such as by weighting Skill Element 1a with a value of 30 and by weighting Skill Element 1b with a value of 70. Thus, the total numerical value for the skill elements of Skill Unit 1 at the Competency Level 1 is equal to 100. Similarly, for Competency Level 2, the skill elements of Skill Unit 1 may each be weighted with the same numerical values, such as by weighting Skill Element 1c with a value of 50 and by weighting Skill Element 1d with a value of 50, where the total numerical value for the skill elements of Skill Unit 1 at the Competency Level 2 is also equal to 100.

In one implementation, in order to demonstrate a specific competency level for a skill, an organizational member may be required to achieve a minimum numerical total (hereinafter referred to as a competency score) for each skill unit of that skill, particularly by completing the units' skill elements corresponding to that competency level. In one such implementation, the minimum competency score may be set to a value (e.g., 100) such that, in order to demonstrate a specific competency level for a skill, an organizational member may be required to successfully complete every skill element corresponding to that competency level for each skill unit of the skill. In another implementation, the minimum competency score may be set to a value (e.g., less than 100) such that, in order to demonstrate a specific competency level for a skill, an organizational member may be required to successfully complete just a portion of the skill elements corresponding to that competency level for each skill unit of the skill.

For example, in FIG. 3, to demonstrate a Competency Level 1 for Skill 1, an organizational member may be required to achieve at least a minimum competency score of 60 for each of Skill Units 1 and 2. In such an example, the organizational member may complete just Skill Element 1b (weighted at 70) to achieve the minimum competency score for Skill Unit 1 at the Competency Level 1. In addition, the organizational member may need to complete Skill Element 2a (weighted at 100) to achieve the minimum competency score for Skill Unit 2 at the Competency Level 1. Since Skill Element 1b is weighted at 70 and Skill Element 2a is weighted at 100, both of which are greater than the minimum competency score of 60, upon successful completion of these skill elements for Skill Units 1 and 2, the CMS 107 may deem the organizational member as being competent at a Competency Level 1 for Skill 1.

In another example, to demonstrate a Competency Level 1 for Skill 1, an organizational member may be required to achieve a minimum competency score of 100 for each of Skill Units 1 and 2. In such an example, the organizational member may need to complete Skill Element 1a (weighted at 30) and Skill Element 1b (weighted at 70) to achieve the minimum competency score for Skill Unit 1 at the Competency Level 1. In addition, the organizational member may need to complete Skill Element 2a (weighted at 100) to achieve the minimum competency score for Skill Unit 2 at the Competency Level 1. Upon successful completion of these skill elements for Skill Units 1 and 2, the CMS 107 may deem the organizational member as being competent at a Competency Level 1 for Skill 1.

The numerical values for the skill elements and the minimum competency score for each skill unit may be predetermined and provided by a user (e.g., an administrator), may be provided by the CMS 107 using default values, or both. In one implementation, data regarding the minimum competency score for each skill unit may be stored in the skills library or may be stored within a skills maps database described in a later section.

Further, the CMS 107 may also receive evidence requirements data for the skill elements of the skills library. As mentioned above, completing a skill element may be defined as providing confirmation that the organizational member is capable of performing the task or providing the information described in the skill element. As such, the evidence requirements data may describe the evidence that an organizational member provides (i.e., evidence requirements) to confirm the member's capability or competency with respect to the skill element. The evidence requirements data may be stored in the skills library within the one or more databases 110. As an aside, the process by which the organizational member provides the evidence and completes the skill elements may occur during the assessment stage, as further described in another section.

In one implementation, the evidence requirements data may indicate that the organizational member is to provide a simple confirmation as evidence in order to confirm that the member is capable of performing the task or providing the information described in a skill element. For example, the simple confirmation may be provided by checking a confirmation checkbox displayed on a graphical user interface (GUI) provided by the CMS 107.

In another implementation, the evidence requirements data may indicate that the organizational member is to provide a narrative answer as evidence in order to confirm that the member is capable of providing the information described in the skill element. The narrative answer may include definitions of terms, a listing of factors, identification of issues, discussions of topics, and/or the like.

In a further implementation, the evidence requirements data received by the CMS 107 may also indicate that, during the assessment stage, this narrative answer is to be compared to a predetermined, standard narrative answer stored in the databases 110. This predetermined, standard narrative answer may be included in the evidence requirements data received by the CMS 107, and may also be stored in the skills library. As further described later with respect to the assessment stage, if the member's answer matches the predetermined, standard narrative answer for a skill element, then the member may be deemed as having demonstrated a competency for that skill element. This predetermined, standard narrative answer may be hereinafter referred to as a predictable measurement answer.

In another implementation, the evidence requirements data may indicate that the organizational member is to provide other forms of evidence in order to confirm that the member is capable of performing the task or providing the information described in a skill element. Such evidence may include a file upload (e.g., video, audio, etc.), hyperlinks to such files, certification or compliance information, third-party written endorsements/observations, a statement that provides recognition of prior experience, and any other evidence known to those skilled in the art. In a further implementation, the file upload or hyperlinked files may include simulations, computer-generated simulations, and/or augmented reality simulations. The use of augmented reality simulations is described in further detail in a later section.

Further, the CMS 107 may also receive training data for the skill elements of the skills library. The training data may include a list or description of training options that may be used by an organizational member in order to become competent with respect to a particular skill element, skill unit, and/or skill. Such training options may include learning references, classroom courses, books/manuals, policies, procedures, online references, recommendations for on the job training, online learning, and/or the like. Such data may be stored in the skills library within the one or more databases 110.

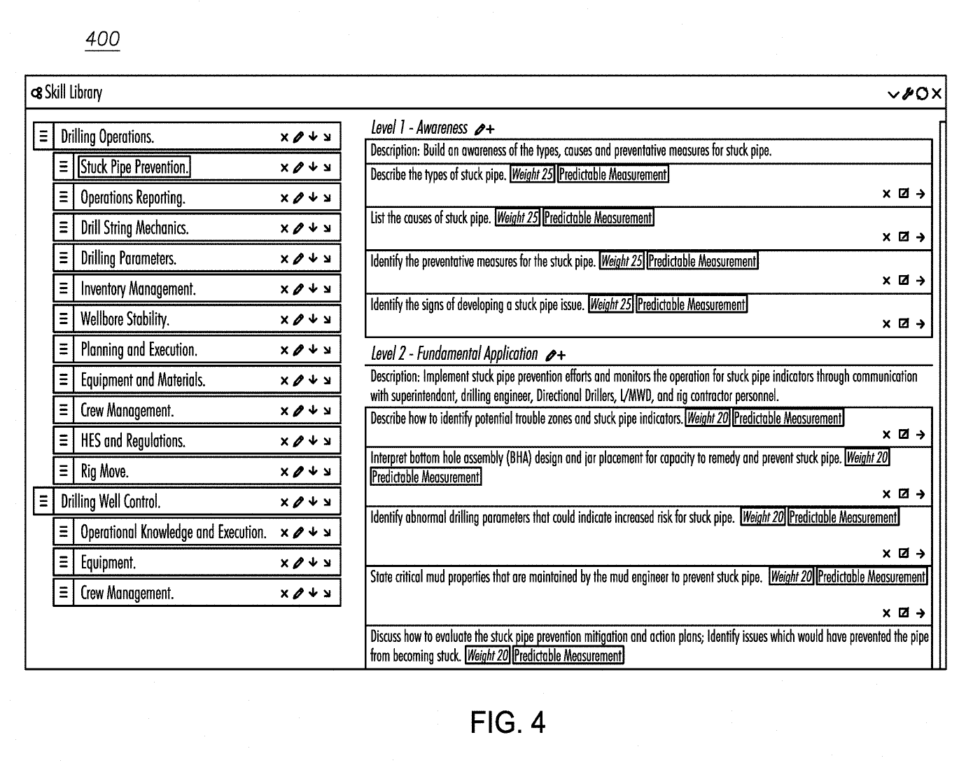

FIG. 4 illustrates an example of a skills library 400 in accordance with implementations of various techniques described herein. The skills library 400 may be stored within one or more databases 110 by the CMS 107, and may be used by an O&G exploration company. As shown, the skills library 400 includes a plurality of skills, including Drilling Operations and Drilling Well Control. Other skills not shown in FIG. 4 may be included in the skills library 400.

As is also shown, the Drilling Operations skill may be categorized into a plurality of skill units, including Stuck Pipe Prevention, Operations Reporting, Drill String Mechanics, Drilling Parameters, and so forth through Rig Move. The Drilling Well Control skill may be categorized into a plurality of skill units, including Operational Knowledge and Execution, Equipment, and Crew Management.

As is further shown, the Stuck Pipe Prevention skill unit is highlighted, and shows that this skill unit may be subcategorized into a plurality of skill elements. In particular, at a Competency Level 1, the skill unit may include four skill elements: “Describe the types of stuck pipe”; “List the causes of stuck pipe”; “Identify the preventative measures for stuck pipe”; and “Identify the signs of developing a stuck pipe issue”. At a Competency Level 2, the skill unit may include five skill elements: “Describe how to identify potential trouble zones and stuck pipe indicators”; “Interpret bottom hole assembly design and jar placement for capacity to remedy and prevent stuck pipe”; “Identify abnormal drilling parameters that could indicate increased risk for stuck pipe”; “State critical mud properties that are maintained by the mud engineer to prevent stuck pipe”; and “Discuss how to evaluate the stuck pipe prevention mitigation and action plans”, etc.

As noted above, these skill elements describe a task, information, and/or the like that an organizational member is to be capable of performing or providing in order to demonstrate a level of competency for the Stuck Pipe Prevention skill unit. The other skill units of the Drilling Operations skill may be similarly subcategorized into skill elements, though not shown in FIG. 4.

As is also shown, the skill elements corresponding to the Competency Level 1 of the Stuck Pipe Prevention skill unit are each weighted at 25, and the skill elements corresponding to the Competency Level 2 of the Stuck Pipe Prevention skill unit are each weighted at 20. As such, total numerical value of the skill elements at each competency level for the Stuck Pipe Prevention skill unit is equal to 100. In one implementation, an organizational member may be required to achieve a minimum competency score of 100 for the skill unit for a particular competency level in order to demonstrate a competence for the skill unit at that level. For example, to demonstrate a Competency Level 1 for the Stuck Pipe Prevention skill unit, an organizational member may need to complete each of the following four skill elements: “Describe the types of stuck pipe”; “List the causes of stuck pipe”; “Identify the preventative measures for stuck pipe”; and “Identify the signs of developing a stuck pipe issue”. In another example, where the competency levels are cumulative, to demonstrate a Competency Level 2 for the Stuck Pipe Prevention skill unit, an organizational member may need to complete each of the four skill elements associated with the Competency Level 1 and each of the five skill elements associated with the Competency Level 2.

In addition, Predictable Measurement markings of each skill element indicate that an organizational member is to provide a narrative answer as evidence to confirm that the member is capable of providing the information described in the skill element. During an assessment stage, this answer may be compared with a predictable measurement answer stored in the skills library. As described above, the evidence requirement of providing the narrative answer for the skill elements have been described in evidence requirements data received by the CMS 107.

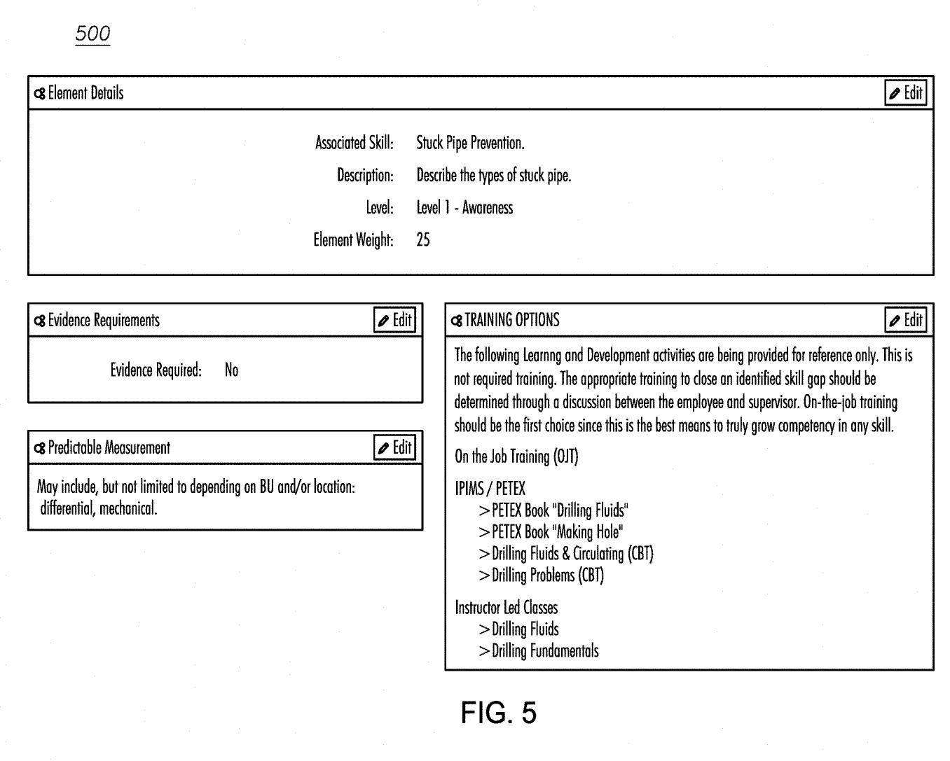

FIG. 5 illustrates an example of a skill element 500 in accordance with implementations of various techniques described herein. In particular, the skill element 500 may be to “Describe the types of stuck pipe” for a Competency Level 1. In addition, the evidence requirements data received by the CMS 107 may have indicated that no evidence is required other than a narrative answer that is to be compared with a predictable measurement answer. As seen in FIG. 5, the predictable measurement answer is “differential” and “mechanical.” FIG. 5 also shows the training options that may be used by an organizational member in order to become competent with respect to the “Describe the types of stuck pipe” skill element, where such options have been described in training data received by the CMS 107.

In one implementation, a user (e.g., an administrator) of the organization may provide the skills data using the Skills Library Module 204 of the CMS 107. In one implementation, the Skills Library Module 204 may be used to view, add, edit, and/or delete skills, skill units, and skill elements to be used in all skills maps. Using the Skills Library Module 204, the user may also provide the weighting data, the minimum competency score for a skill unit and/or skill, the evidence requirements data (including a predictable measurement answer), and the training data for the skill elements of the skills library. In a further implementation, the Skills Library Module 204 may include: a search function, including a find and replace of text option, and an ability to search for and/or replace a skill, skill unit, skill element count, and tab per each skills map.

As is discussed in a later section, the Evidence Module 221 and/or the Augmented Reality Module 224 may be used by an organizational member to provide the evidence indicated by the evidence requirements data in order to confirm that the member is capable of performing the task or providing the information described in the skill elements. In addition, as is further discussed in a later section, the Training Module 222 may be used by an organizational member to access the options indicated by the training data (e.g., learning references, classroom courses, books/manuals, policies, procedures, online references, recommendations for on the job training, and/or online learning) associated with the skill elements.

### 3. Skills Map Database

As mentioned above, one or more build stage modules 200 of the CMS 107 may be used to build a skills maps database based, at least in part, on the organizational database and the skills library. In particular, the CMS 107 may receive data regarding which skills are to be associated with particular positions, locations, units, and/or members of an organization, which competency levels are to be used for particular positions, locations, units, and/or members of an organization, and/or the like. Data identifying the skills associated with particular positions, locations, units, and/or organizational members may hereinafter be referred to as skills maps data.

In particular, the skills maps data may be used to create, store, and assign a plurality of skills maps. A skills map may include one or more skills that are associated with a particular position, a particular location, a job function, an organizational unit, and/or an organizational member, where the one or more skills are derived from the skills library. Using the skills map data, a skills map may be created for each of these particular positions, particular locations, job functions, organizational units, and/or organizational members indicated by the skills map data.

Further, organizational members identified by the skills maps data or involved with the particular positions, particular locations, job functions, and/or organizational units may each be assigned one or more skills maps. In particular, the CMS 107 may use the organizational database to determine which members are involved with the particular positions, particular locations, job functions, and/or organizational units, and the CMS 107 may then assign the skills maps these members. A record of the skills maps created and the organizational members assigned to them may be stored in the skills maps database within the databases 110.

For example, for an O&G exploration company, the skills maps data may indicate that a drilling engineer skills map is to be formed, where this map is to include the Drilling Operations skill and the Drilling Well Control skill described above with respect to FIGS. 4-5, and where the map is to be assigned to all drilling engineers of the company. In another example, the skills maps data may indicate that a drilling operations skills map is to be formed, where this map is to include the Drilling Operations skill and the Drilling Well Control skill described above with respect to FIGS. 4-5, and where the map is to be assigned to all employees of the company involved with drilling operations.

In one implementation, a skills map may include any number of skills. Further, an organizational member may be assigned any number of skills maps. For example, for an O&G exploration company, a drilling engineer may be assigned the drilling engineer skills map (described above), a completions engineer skills map, and a rig management skills map. In a further implementation, the CMS 107 may generate a member profile page for each organizational member, where the profile page may include a list of and/or hyperlink to all skills maps assigned to the member. In such an implementation, by using the hyperlinks to the skills maps, the member may perform an assessment of the skills of these skills maps, as further described in a later section.

In addition, a particular position, a particular location, a job function, an organizational unit, and/or an organizational member may be assigned one or more competency levels for the skills of any assigned skills maps. In particular, any combination of competency levels may be assigned to the skills of a skills map for a particular position, a particular location, a job function, an organizational unit, and/or an organizational member. For example, a drilling engineer may be assigned a Competency Level 2 for the Drilling Operations skill and a Competency Level 1 for the Drilling Well Control skill.

In one implementation, a user (e.g., an administrator) of the organization may provide the skills maps data using the Skills Maps Module 205 of the CMS 107. In one implementation, the Skills Maps Module 205 may be used to view, add, assign, edit, and/or delete skills maps, skills among the skills maps, and the like. In addition, the Competency Levels Module 202 may be used to view, add, edit, and/or delete competency levels for a particular position, a particular location, a job function, an organizational unit, and/or an organizational member. In a further implementation, the minimum competency score for a skill unit and/or skill may be set using the Skills Maps Module 205, rather than the Skills Library Module 204 as described above.

### 4. Other Modules

Other build stage modules 200 of the CMS 107 not described above may also be used to generate and/or manage a competency management framework for an organization.

The modules 200 may include an Administration Module, which may include a Global/BU Administration Module, which may be used to view, add, edit, and/or delete administrators of the CMS 107, including viewing rights to global or organizational unit dashboards. The Administration Module may also include the Units Module 201, the Competency Levels Module 202, the Members Module 203, the Skills Library Module 204, and the Skills Maps Module 205, all of which are described above. The Administration Module may also include a Certification Types Module, which may be used to view, add, edit, and/or delete certification types, including validity.

Other modules 200 may include a Search Module, which may allow for managers and supervisors to search for organizational members per organizational unit, team, or globally who meet or exceed selected search criteria for a particular skill unit and corresponding competency level. Restrictions to the Search Module may apply based on the role of the manager or supervisor. The Search Module may also include an ability to search for keywords against all data within an organizational member profile, including assessments, competency-based development plans, competency performance objectives, certifications, and job history. Other modules 200 may include a Video Tutorials Module, which may allow for the playing of videos to assist in the rapid learning of the functionalities within each CMS 107 module. The modules 200 may include a Help Menu Module, which may produce a self-populated menu, and which may include internal and external links that can be customized by a user. The modules 200 may include a Password Generator Module, which may allow for the generation of system automated passwords based on predetermined character lengths and character types. The modules 200 may include a Menu/Information Module, which may include an ability to change menu titles and module information text.

The modules 200 may further include a Language Module, which may allow for the translation of menu titles and module information text. The modules 200 may include a user interface (UI) Color Module, which may include a self-selected default color palette used by organizational members to assist with color blindness. The modules 200 may include a Tooltip Module, which would administer tool tips within the software, and would allow for amendments and/or rewording of tips through a tool tips library. The modules 200 may include an Export Dashboard Module, which may allow for exporting a global dashboard and/or an organizational dashboard to another program or to a file format via a toolbar. The modules 200 may include an Email Notification Module, which may allow for the ability to inform organizational members about software changes and/or email communications regarding competency standards, skills, job functions, organizational units, or a global message. The modules 200 may include a Skills library Notification Module, which may be used to inform organizational members about a technical skill, unit, or element change that can affect their competency scores. The modules 200 may include a Bitmap Creator Module, which may allow for the creation of a bitmap image via a toolbar, which can be used in emails or presentations. The modules 200 may include a Profile Page Module, which may allow for a photo placeholder, and may display an organizational members name, initials, and skill data. The modules 200 may include a Communicator Module, which may provide a visual and functional link to other communications programs, which may enable managers, supervisors, and employees to communicate via a communications program without leaving the CMS 107.

### 5. Method

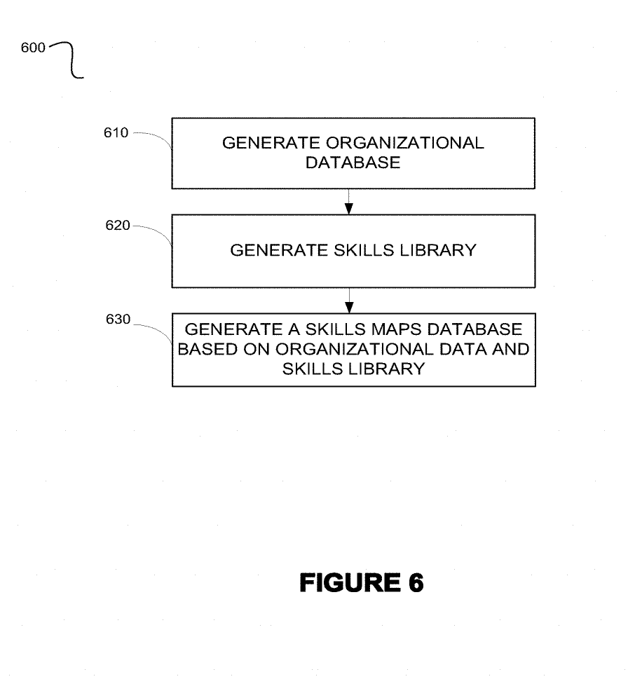

FIG. 6 illustrates a flow diagram of a method 600 for generating a competency management framework for an organization in accordance with implementations of various techniques described herein. In one implementation, method 600 may be at least partially performed by a computing system, such as the computing system 102 discussed above. It should be understood that while method 600 indicates a particular order of execution of operations, in some implementations, certain portions of the operations might be executed in a different order. Further, in some implementations, additional operations or steps may be added to the method 600. Likewise, some operations or steps may be omitted.

At block 610, the computing system may generate an organizational database. In particular, the computing system may receive organizational data for the organization, which may then be stored in the organizational database. As noted above, such data may include data regarding organizational units, organizational members, hierarchy of organizational members and/or units, job functions and/or titles of the organizational members, and so forth.

At block 620, the computing system may generate a skills library. In particular, the computing system may receive skills data for the organization. As noted above, such data may include data regarding skills used within the organization, competency levels, and the like, where this data may be stored as a skills library within one or more databases. The skills data may include the names for each skill, along with information regarding one or more skill units, one or more skill elements, and one or more competency levels for each skill.

The computing system may also receive weighting data for the skill elements of the skills library, where the weighting data may include numerical values to be assigned to the skill elements of the skills library. Further, the computing system may also receive training data for the skill elements of the skills library. Such data may also be stored in the skills library within the one or more databases.

In addition, the computing system may also receive evidence requirements data for the skill elements of the skills library. The evidence requirements data may describe the evidence that an organizational member is to provide in order to confirm the member's capability with respect to the skill element. Such data may be stored in the skills library within the one or more databases. In one implementation, the evidence requirements data may indicate that the organizational member is to provide a simple confirmation as evidence in order to confirm that the member is capable of performing the task or providing the information described in a skill element. In another implementation, the evidence requirements data may indicate that the organizational member is to provide a narrative answer as evidence in order to confirm that the member is capable of providing the information described in the skill element. In a further implementation, the evidence requirements data may also indicate that, during the assessment stage, this narrative answer is to be compared to a predictable measurement answer.

At block 630, the computing system may generate a skills maps database based on the organizational data and the skills library. In one implementation, the computing system may receive skills maps data regarding skills associated with particular positions, locations, units, and/or members of an organization, competency levels for particular positions, locations, units, and/or members of an organization, and the like. In particular, the skills maps data may be used to create, store, and assign a plurality of skills maps. A skills map may include one or more skills that are associated with a particular position, a particular location, a job function, an organizational unit, and/or an organizational member, where the one or more skills are derived from the skills library.

In sum, the build stage modules 200 of the CMS 107 may be used to generate the competency management framework for an organization. Specifically, the build stage modules 200 may be used to generate an organizational database, a skills library, and a skills maps database for the organization.

### B. Assessment Stage Modules

As noted above, the assessment stage modules 220 may be used to assess current competencies of organizational members via the competency management framework established using the build stage modules 200, verify these competencies, and improve competencies to desired levels based on a number of factors, where such improvement may be achieved via training or other type of development activity. In particular, the assessment stage may include three phases: (i) a member assessment, (ii) a supervisor assessment, and (iii) a verifier assessment.

### 1. Member Assessment

As noted earlier, an organizational member may be assigned one or more skills maps, where the skills map may represent a collection of one or more skills. In addition, the organizational member may be assigned one or more competency levels for the skills of the skills maps. Further, in order to demonstrate a particular competency level for a skill, an organizational member may be required to complete the skill elements corresponding to that competency level for each skill unit of the skill. Completing the skill element may be defined as providing confirmation that the organizational member is capable of performing the task or providing the information described in the skill element. Each skill element may have evidence requirements that an organizational member must provide in order to confirm the member's capability or competency with respect to the skill element.

As part of the first phase of the assessment stage, i.e., the organizational member assessment phase, the organizational member may complete a self-assessment of a skill of an assigned skills map. In particular, for an assigned competency level for the skill, the organizational member may perform the self-assessment by completing the skill elements corresponding to that competency level for each skill unit of the skill.

In a further implementation, the CMS 107 may use the assessment stage modules 220 to display one or more assigned skills maps to an organizational member, including the skills, skill units, and skill elements corresponding to the assigned skills maps. The organizational member may be able to access and view a member profile page, where the profile page may include one or more hyperlinks to all skills maps (and thus skills) assigned to the member. As an example, the organizational member may use the hyperlinks to the skills maps to perform the self-assessment of one or more skills.

Using the hyperlinks, the organizational member may be able to view the skills for the assigned skills maps, the skill units for those skills, and the skill elements at the assigned competency level for those skill units. Further, using the hyperlinks to the skills maps, the organizational member may be able to view the evidence requirements for these skill elements.

For example, for an O&G exploration company, a drilling engineer may be assigned the drilling engineer skills map, where this map includes the Drilling Operations skill and the Drilling Well Control skill described above with respect to FIGS. 4-5. The drilling engineer may be assigned a Competency Level 2 for the Drilling Operations skill and a Competency Level 1 for the Drilling Well Control skill. In such an example, from the member profile page, the drilling engineer may be able to view the drilling engineer skills map on his member profile page, and may be able to view the skill elements at the assigned competency levels for the skill units corresponding to the Drilling Operations skill and the Drilling Well Control skill.

After being able to view the skills and the evidence requirements for the assigned skills maps, the organizational member may proceed with the self-assessment of his skills of the assigned skills maps. The organizational member may perform the self-assessment by providing self-assessment data to the CMS 107 for one or more skill elements corresponding to an assigned competency level for one or more skills of an assigned skills map.

In particular, to perform a self-assessment of a skill of an assigned skills map, the organizational member may provide the self-assessment data to the CMS 107 for all skill elements of the skill that correspond to an assigned competency level. The self-assessment data may include any evidence corresponding to the evidence requirements for the skill elements. In particular, the self-assessment data may include any evidence needed to complete the skill elements of the assigned skills maps, including a simple confirmation, narrative answer, and/or the like. In particular, the organizational member may provide the self-assessment data based on the evidence requirements for these skill elements.

In one such implementation, the self-assessment data may be a simple confirmation that the member is capable of performing the task or providing the information described in a skill element, where such data may be a simple input that causes a check of a confirmation checkbox provided by a GUI interface of the CMS 107. Similarly, the self-assessment data may instead be a simple input indicating that the member is not capable of performing the task or providing the information described in a skill element.

In another implementation, the self-assessment data may be other types of evidence, such as a narrative answer, a file upload (e.g., video, audio, etc.), hyperlinks to such files, certification or compliance information, third-party written endorsements/observations, a statement that provides recognition of prior experience, and any other evidence known to those skilled in the art. As discussed above, for some implementations, the narrative answer provided by the organizational member may be compared to a predictable measurement answer, as further discussed below.

As noted in an earlier example with respect to FIGS. 4-5, the evidence requirements for the skill elements of the Stuck Pipe Prevention skill unit of the Drilling Operations skill are shown by the Predictable Measurement markings of each skill element. These markings indicate that a drilling engineer is to provide narrative answers as evidence to complete each skill element, where the answers may be compared with a predictable measurement answers stored in the skills library.

In one implementation, an Evidence Module 221 may be used by an organizational member to provide the evidence described above to the CMS 107, such as by uploading a narrative answer to the Evidence Module 221, uploading a file to the Evidence Module 221, and so forth. In one such implementation, each skill element of the assigned skills maps may provide a hyperlink to the Evidence Module 221 to allow a user (e.g., organizational member) to provide the self-assessment data for that skill element. The Evidence Module 221 may also be hyperlinked to each of these skill elements within the skills library via the Skills Library Module 204. Each entry uploaded to the Evidence Module 221 may be given a file reference icon, where the icon can be used to determine an application needed to access the entry on a device (e.g., remote device 114). The Evidence Module 221 may be configured to accept any file type and format known to those skilled in the art.

In another implementation, the evidence provided to the CMS 107 may include one or more simulations, computer-generated simulations, and/or augmented reality simulations. In such an implementation, the organizational member may use an Augmented Reality Module 224 to upload and/or generate an augmented reality simulation to be used as evidence. In particular, the Augmented Reality Module 224 may be used to record (e.g., on video) an augmented reality simulation performed by the organizational member using an augmented reality device, and then upload or hyperlink to the simulation as evidence. For example, the augmented reality simulation may be a simulation of a task performed by the organizational member, where the task corresponds to a particular skill element. The Augmented Reality Module 224 may be linked to the Evidence Module 221, such that the simulation may be transferred from the Augmented Reality Module 224 to the Evidence Module 221. The augmented reality simulation may be produced via any augmented reality device known in the art (e.g., Microsoft HoloLens, Google Glass, and/or the like), where the device may allow for a simulated assessment in a controlled environment.

After providing the self-assessment data to the CMS 107 for all skill elements for each skill unit of a skill of an assigned skills map corresponding to an assigned competency level, the CMS 107 may determine a self-assessment competency score for each skill unit of the skill. Such a competency score may be based on the weighting data for the skill elements of the skill units, particularly the numerical values for the skill elements completed by the organizational member (i.e., the skill elements for which the member provided the required evidence that he is capable of performing the task or providing the information described in the skill elements). The numerical values for these skill elements may be summed for every skill unit to determine a self-assessment competency score for the skill unit. A self-assessment competency score for a skill may be determined based on an average competency score for the skill units, a percentage of completed skill units, and/or the like.

In one implementation, the CMS 107 may determine a self-assessment competency score for a skill based on an average competency score for the skill units, a percentage of skill units having all skill elements completed, and/or the like. For example, as described above with respect to FIGS. 4-5, for a drilling engineer successfully completing the skill elements for the Stuck Pipe Prevention skill unit of the Drilling Operations skill at a Competency Level 1, the CMS 107 may determine the self-assessment competency score for this skill unit to be equal to 100. In this example, the drilling engineer may have provided the evidence required (e.g., a narrative answer) to an Evidence Module 221 for each of the four skill elements of the Stuck Pipe Prevention skill unit at the Competency Level 1, where each skill element is weighted with a numerical value of 25. By similarly completing each skill unit of the Drilling Operations skill, the CMS 107 may then average the skill unit competency scores and determine that the self-assessment competency score for the Drilling Operations skill is equal to 100.

### 2. Supervisor Assessment

A supervisor of an organizational member may use the CMS 107 to perform a supervisor assessment of the organizational member. The supervisor assessment may include reviewing the organizational member's self-assessment. In particular, the supervisor may review the member's self-assessment data and self-assessment competency score.

A supervisor may be an individual within an organization who is assigned one or more organizational members and has the responsibility of reviewing the self-assessment for these organizational members. In one implementation, the supervisor may be another organizational member within the organization.

A member may be assigned the role of supervisor based on an assessment hierarchy of organizational members within the organization or within an organizational unit. This hierarchy may be included in the organizational database of the CMS 107, and may have been provided by a user (e.g., an administrator) using the Units Module 201 or the Members Module 203 of the CMS 107. For example, the organizational database may include a list of assigned supervisors for each engineer of an O&G company.

To perform the supervisor assessment, the supervisor may use one or more of the assessment stage modules 220 to view the one or more assigned skills maps of an organizational member, including the skills, skill units, and skill elements corresponding to the assigned skills maps at one or more assigned competency levels. The supervisor may view the one or more assigned skills maps of an organizational member using the member's profile page.

In addition, the supervisor may be able to view evidence (i.e., self-assessment data) submitted by the organizational member as part of the member's self-assessment, where this evidence may include any evidence submitted by the member to complete the skill elements of the assigned skills maps.

Based on the assigned skills maps and the self-assessment data, the supervisor may provide supervisor assessment data to the CMS 107. In particular, for each skill element at the assigned competency level for an assigned skills map, the supervisor may review the self-assessment data submitted. After reviewing the self-assessment data, the supervisor may confirm or deny that the organizational member is capable of performing the task or providing the information described in the skill element. As such, the supervisor may confirm or deny the competency of the organizational member with respect to each skill element, skill unit, and/or skill by evaluating the self-assessment data.

In particular, the supervisor assessment data may be data indicating a confirmation or denial of the member's competency with respect to each skill element. It may also be said that the supervisor assessment data may be data indicating a confirmation or denial of the self-assessment competency score for a skill unit and/or skill.

The supervisor assessment data may be an input indicating a confirmation or denial of the member's capability with respect to a skill element, and such input may be provided by checking a confirmation or denial checkbox displayed on a GUI interface provided by the CMS 107. The supervisor may provide the supervisor assessment data for each skill element of a skill from an assigned skills map that corresponds to an assigned competency level.

For example, the organizational member may have provided a simple confirmation as self-assessment data in order to confirm that the member is capable of performing the task or providing the information described in a skill element. The supervisor may confirm or deny the member's capability based on the supervisor's knowledge of and experience with the member.

In another example, the organizational member may have provided a narrative answer as self-assessment data in order to confirm that the member is capable of performing the task or providing the information described in a skill element, where the answer is to be compared with a predictable measurement answer. The supervisor may then view the narrative answer and the predictable measurement answer, compare them, and then determine whether the narrative answer matches the predictable measurement answer. If they match, then the supervisor may confirm the member's capability of performing the task or providing the information described in the skill element. If they do not match, then the supervisor may deny that the member is capable of performing the task or providing the information described in the skill element.

In yet another example, the organizational member may have provided an augmented reality simulation as self-assessment data in order to confirm that the member is capable of performing the task or providing the information described in a skill element. The supervisor may confirm or deny the member's capability based on the quality of performance exhibited by the member in the augmented reality simulation.

Upon completing the supervisor assessment for the skill elements of the assigned skills maps that were completed by the organizational member, the CMS 107 may determine one or more supervisor assessment competency scores for the skill units and/or skills of the assigned skills maps. The supervisor assessment competency score for a skill unit may be based on the weighting data for the skill elements of the skill units. In particular, the numerical values for the skill elements that were confirmed by the supervisor may be summed for every skill unit to determine a supervisor assessment competency score for the skill unit, whereas the skill elements that were denied by the supervisor are not included in the competency score for the unit. The supervisor assessment competency score for a skill may be determined based on an average supervisor assessment competency score for the skill units, a percentage of completed skill units, and/or the like.

After determining the one or more supervisor assessment competency scores for the skill units and/or skills of the assigned skills maps, the supervisor may discuss the self-assessment and the supervisor assessment with the organizational member. In one implementation, the supervisor may mark one or more skill elements of the assigned skills maps for review and discussion with the organizational member.

As noted earlier, in one implementation, in order to demonstrate a specific competency level for a skill, an organizational member may be required to achieve a minimum competency score for each skill and for each skill unit of that skill at the competency level. In one such implementation, the minimum competency score for a skill unit or skill may be set to a value (e.g., 100) such that, in order to demonstrate a specific competency level for the skill, an organizational member may be required to successfully complete every skill element corresponding to that competency level for each skill unit of the skill.

On one hand, the supervisor assessment competency score for the skill may match the self-assessment competency score for the skill. In such an implementation, if the supervisor assessment competency score is greater than or equal to a minimum competency score, then the self-assessment data, the supervisor assessment data, and the assigned skill may be transmitted to a verifier for further review, as described below. In a further implementation, the verifier may receive the self-assessment data, the supervisor assessment data, and the assigned skill only when every skill of an assigned skills map has a supervisor assessment competency score greater than or equal to the minimum competency score.

On the other hand, the supervisor assessment competency score for the skill may not match the self-assessment competency score for the skill. In particular, the supervisor assessment competency score may be less than a target (e.g., minimum) competency score for the skill. In such an implementation, the supervisor may assign one or more training options to the organizational member in order to improve the member's competency with respect to a particular skill element of the skill, such as a skill element that was denied by the supervisor during the supervisor assessment. A supervisor denying a competency or capability for a skill element for a member may indicate that the member has a competency gap for that skill element.

After the organizational member uses the training options to improve his competency with respect to one or more particular skill element of a skill, the member may perform another self-assessment and the supervisor may perform another supervisor assessment. The member and the supervisor may continue to perform their assessments until the supervisor assessment competency score for the skill is greater than or equal to the target competency score.

The Training Module 222 may be used by an organizational member to access the training options (e.g., learning references, classroom courses, books/manuals, policies, procedures, online references, recommendations for on-the-job training, and/or online learning) associated with a skill element. The Training Module 222 may be accessible from the skills library.

The Training Module 222 may include a Competency-Based Development Module (CBD Module) and a Competency Performance Objectives Module (CPO Module). In particular, the CBD Module may allow for the viewing of potential learning activities to assist in bridging competency gaps identified during the supervisor assessment, and then transferring these activities to the CPO Module to create one or more development objectives. The CPO Module may be configured to prioritize competency gaps against targeted learning activities against completion dates.

In one example, the supervisor assessment competency score for a skill may be assigned to one of the following ranges in conjunction with certain colors: 0 to 50 (red), 51 to 99 (yellow), and 100 (green), where the member's supervisor assessment competency scores for the skills of assigned skills maps may be displayed by the CMS 107 using these colors. Upon completion of the self-assessment and supervisor assessment, a competency-based development plan and competency performance objectives may be generated via the CBD and CPO Modules based on skills with a color-coding of red, yellow, green, and/or any other color combination. In particular, red may signify development areas, yellow may signify progress to the minimum competency score, and green may signify as having met the minimum competency score.

### 3. Verifier Assessment

If an organizational member has demonstrated a specific competency level for a skill based on the supervisor assessment described above, then the self-assessment data, the supervisor assessment data, and the assigned skill may be transmitted to a verifier for a verifier assessment. In one implementation, the verifier assessment for a skill may be performed only if the organizational member has demonstrated a predetermined (e.g., minimum) competency level (e.g., a Competency Level 3) for the skill during the supervisor assessment. As noted earlier, in order to demonstrate a specific competency level for a skill, an organizational member may be required to achieve a supervisor assessment competency score for the skill that is greater than or equal to a target competency score at that specific competency level.

The verifier may be an individual within an organization who is assigned one or more organizational members and has the responsibility of verifying the self-assessment and supervisor assessment for these organizational members. In one implementation, the verifier may be another organizational member within the organization. Similar to the supervisor, a member may be assigned the role of verifier based on an assessment hierarchy of organizational members within the organization or within an organizational unit. In another implementation, the verifier may be an individual not involved with the organization.

To perform the verifier assessment, the verifier may use one or more of the assessment stage modules 220 to view the self-assessment data, the supervisor assessment data, and the one or more assigned skills at one or more assigned competency levels. The verifier assessment is to confirm that the member's and supervisor's assessments were valid, fair and reliable, and that all evidence entries are valid, sufficient, current and authentic. In some implementations, the verifier assessment may be used on an interim basis during the supervisor assessment process in order to verify the member's self-assessment data (i.e., evidence).

Based on the self-assessment data, the supervisor assessment data, and the assigned skill, the verifier may provide verifier assessment data to the CMS 107. Based on the self-assessment data, the supervisor assessment data, and the assigned skill, the verifier may confirm or deny that the organizational member is capable of performing the task or providing the information described in the skill element. As such, the verifier assessment data may be an input indicating a confirmation or denial of the member's capability with respect to a skill element, and may be provided by checking a confirmation or denial checkbox displayed on a GUI interface provided by the CMS 107.

Upon successful completion of the verifier assessment (i.e., confirmation of competence), the CMS 107 may indicate that the organizational member has demonstrated the assigned competency level for an assigned skill and/or skills map. In particular, the CMS 107 may indicate that the supervisor assessment competency score is accurate, and is to be the final competency score assigned to a member for an assigned skill. In addition, the verifier assessment, supervisor assessment, and self-assessment described above may be repeated for every skill of an assigned skills map.

Upon an unsuccessful completion of the verifier assessment (i.e., denial of competence), the verifier may assign one or more training options to the organizational member in order to improve the member's competency with respect to a particular skill element of the skill, such as through the use of the Training Module 222. The failure to be deemed competent for a skill or skills map and the assignment of training options may also be reported to the supervisor. The supervisor may repeat the supervisor assessment upon the member's completion of the training options and new self-assessment.

### 4. Other Modules

Other assessment stage modules 220 of the CMS 107 not described above may also be used to assess current competencies of organizational members via the competency management framework established using the build stage modules 200, verify these competencies, and improve competencies to desired levels based on a number of factors.

In one implementation, the assessment stage modules 220 may include a Delegation Module 223, which may be configured to indicate if a supervisor is not proficient enough to assess skills of an organizational member. For example, the employee may have conducted a self-assessment for skill elements at a Competency Level 3 for a skill of an assigned skills map, and his supervisor may have only demonstrated a Competency Level 2 for that skill. In such an example, the Delegation Module 223 may then delegate the supervisor assessment to another individual in the organization who has demonstrated at least a Competency Level 3 for the skill. This may be referred to as a forced delegation, as it is performed by the Delegation Module 223 of the CMS 107. In another scenario, a supervisor may voluntarily delegate the supervisor assessment to another person who has demonstrated at least a Competency Level 3 for the skill. This may be referred to as a voluntary delegation.

The assessment stage modules 220 may also include a Member Profile Module, which may allow for an ability to generate and/or view one or more member profile modules, and may be used to interact with other modules, such that the member profiles may be accessible in those modules.

The assessment stage modules 220 may also include a Certification Module, which may allow for the uploading of all certification and compliance information associated with each job function and/or organizational member, where any information which is associated with an expiration date will be monitored and communicated to the member by internals set by a CMS 107 administrator, and where the certification and compliance information may be used as evidence.

The assessment stage modules 220 may further include a number of other modules such as: a Notifications Alerts Module, which may be used to notify the member and/or supervisor of each completed assessment progress through email, and may be used to include a pending and notification header portlet on each member profile page; an Exemption Module, which may allow for the exemption of any member from assessment due to recognition of prior learning/experience; an Upgrade to Certification Module, which may be used to track compliance against policy and procedure including expiration dates and updates against changes, and which may include functionality for supervisor approvals; a Competency Review Board (CRB) Module, which may be used to prepare self-assessment data for review by CRB members via the CMS 107, and which may be assigned to a CRB administrator who would control all aspects of the CRB process and/or Competency Level 4 members only; and an Offline Module, which may allow for the uploading of self-assessment data to a device, and which may upload the self-assessment data to the CMS 107 when connectivity is established.

### 5. Method

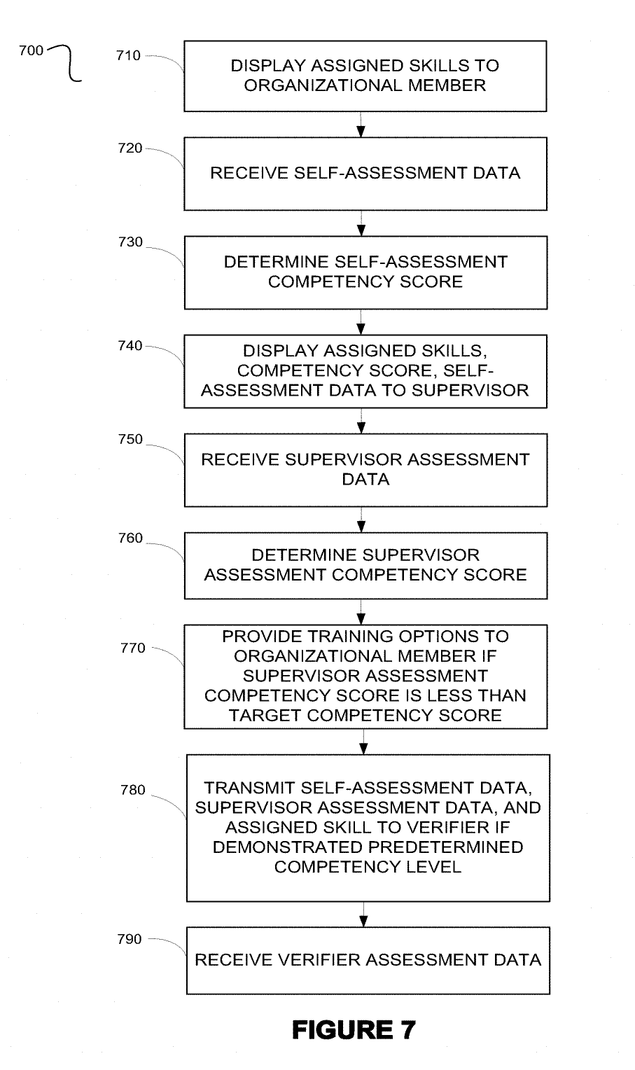

FIG. 7 illustrates a flow diagram of a method 700 for assessing a competency for an organizational member in accordance with implementations of various techniques described herein. In one implementation, method 700 may be at least partially performed by a computing system, such as the computing system 102 discussed above. It should be understood that while method 700 indicates a particular order of execution of operations, in some implementations, certain portions of the operations might be executed in a different order. Further, in some implementations, additional operations or steps may be added to the method 700. Likewise, some operations or steps may be omitted.

At block 710, the computing system may display an assigned skill to an organizational member of the organization, where the assigned skill includes one or more assigned skill units, and where the one or more assigned skill units include one or more assigned skill elements and one or more evidence requirements for the assigned skill elements. In addition, the one or more assigned skill elements may correspond to one or more assigned competency levels. Further, the assigned skill may be part of an assigned skills map.

At block 720, the computing system may receive self-assessment data from the organizational member, where the self-assessment data corresponds to the one or more evidence requirements for the assigned skill elements. In particular, the self-assessment data may include any evidence needed to complete the assigned skill elements of the assigned skills maps, including a simple confirmation, narrative answer, an augmented reality simulation, and/or the like.

At block 730, the computing system may determine a self-assessment competency score for the skill based on the self-assessment data. The self-assessment competency score may be based on weighting data for the assigned skill elements of the skill, particularly the numerical values for the skill elements for which self-assessment data was received from the organizational member.

At block 740, the computing system may display the one or more assigned skill elements, the self-assessment data, and the self-assessment competency score to a supervisor of the organization. A supervisor may be an individual within an organization who is assigned one or more organizational members and has the responsibility of reviewing the self-assessment for these organizational members.

At block 750, the computing system may receive supervisor assessment data from the supervisor, where the supervisor assessment data may be an input indicating a confirmation or denial of the member's competency with respect to the one or more assigned skill elements. In particular, for each skill element at the assigned competency level for an assigned skill, the supervisor may review the self-assessment data. Based on the self-assessment data, the supervisor may confirm or deny that the organizational member is capable of performing the task or providing the information described in the skill element.

In one implementation, the self-assessment data includes a narrative answer. In such an implementation, the received supervisor assessment data may be based on a comparison of the narrative answer with a predictable measurement answer. In another implementation, the self-assessment data includes an augmented reality simulation. In such an implementation, the supervisor may confirm or deny the member's capability based on the quality of performance exhibited by the member in the augmented reality simulation.

In another implementation, prior to block 750, the computing system may determine if the supervisor has demonstrated competency with respect to the one or more skill elements assigned to the member. In particular, the computing system may use the Delegation Module 223 to make this determination, as explained above. If the computing system determines that the supervisor has not demonstrated competency with respect to the skill elements, then the computing system may delegate the supervisor role to a different individual of the organization, such as through a forced delegation. The method 700 may then proceed to block 750 with this different individual in the role of supervisor.

At block 760, the computing system may determine a supervisor assessment competency score for the skill based on the supervisor assessment data. The supervisor assessment competency score for a skill unit may be based on the weighting data for the skill elements of the skill units. The numerical values for the skill elements that were confirmed by the supervisor may be summed for every skill unit to determine a self-assessment competency score for the skill unit, whereas the skill elements that were denied by the supervisor are not included in the competency score for the unit. In a further implementation, a supervisor assessment competency score for a skill may be determined based on an average supervisor assessment competency score for the skill units, a percentage of completed skill units, and/or the like.

At block 770, the computing system may provide one or more training options to the organizational member if the supervisor assessment competency score is less than a target competency score. In such an implementation, the supervisor may assign one or more training options to the organizational member in order to improve the member's competency with respect to a particular skill element of the skill, such as a skill element that was rated lower by the supervisor during the supervisor assessment when compared with the member's self-assessment.

At block 780, the computing system may transmit the self-assessment data, the supervisor assessment data, and the assigned skill to a verifier if the organizational member has demonstrated a predetermined competency level for the skill based on the supervisor assessment competency score. For example, the organizational member may have demonstrated the predetermined competency level for the skill if the supervisor assessment competency score for the skill is greater than or equal to the target competency score for the predetermined competency level. The verifier may be an individual within an organization who is assigned one or more organizational members and has the responsibility of verifying the self-assessment and supervisor assessment for these organizational members.

At block 790, the computing system may receive verifier assessment data from the verifier, where the verifier assessment data may be an input indicating a confirmation or denial of the member's competency with respect to the assigned skill. Upon successful completion of the verifier assessment (i.e., confirmation of competence), the computing system may indicate that the organizational member has demonstrated the assigned competency level for an assigned skill. Upon an unsuccessful completion of the verifier assessment (i.e., denial of competence), the verifier may assign one or more training options to the organizational member in order to improve the member's competency with respect to the assigned skill.

In one implementation, method 700 may be repeated for each assigned skill of an assigned skills map. In another implementation, the method 700 may be repeated for each assigned skill of an assigned skills map for every organizational member of an organizational unit.

In sum, the assessment stage modules 220 may be used to assess current competencies of organizational members via the competency management framework established using the build stage modules 200, verify these competencies, and improve competencies to desired levels based on a number of factors, where such improvement may be achieved via training. The assessment stage may include three phases: a member assessment, a supervisor assessment, and a verifier assessment.

### C. Analysis Stage Modules

As noted above, the analysis stage modules 240 may be used to analyze individual, team, and organizational competency information obtained during the assessment stage. In one implementation, the modules 240 may be used to analyze the competency information in real-time. In particular, the modules 240 may use the assigned skills maps, the self-assessment data, the self-assessment scores, the supervisor assessment data, the supervisor assessment competency scores (whether finalized by the CMS 107 or not), and/or the verifier assessment data to analyze competencies for organizational members and/or organizational units.

### 1. History

In one implementation, a History Module 250 may be used to track the history of a self-assessment and a supervisor assessment for an organizational member with respect to one or more assigned skills and/or skills maps.

In particular, as the CMS 107 receives the self-assessment data, the self-assessment competency score, the supervisor assessment data, the supervisor assessment competency score, and/or the verifier assessment data, the History Module 250 may record the date and/or time that such data is received, where this record of date and/or time may hereinafter be referred to as history data. In addition, the History Module 250 may also record the history data when the one or more assigned skills and/or skills maps are assigned to the organizational member. The history data may be recorded in real time as the self-assessment data, the self-assessment competency score, the supervisor assessment data, and/or the supervisor assessment competency score are received. In particular, the history data may be recorded for each instance that a self-assessment or supervisor assessment of a skill element, skill unit, or skill is completed.

The data recorded by the History Module 250 may be linked to a member profile page, such that the history data may follow the member throughout his tenure with the organization. The History Module 250 may be configured to display the history data that it records, such as for each assigned skill and/or skills map. In one implementation, the History Module 250 may also display the history data graphically.

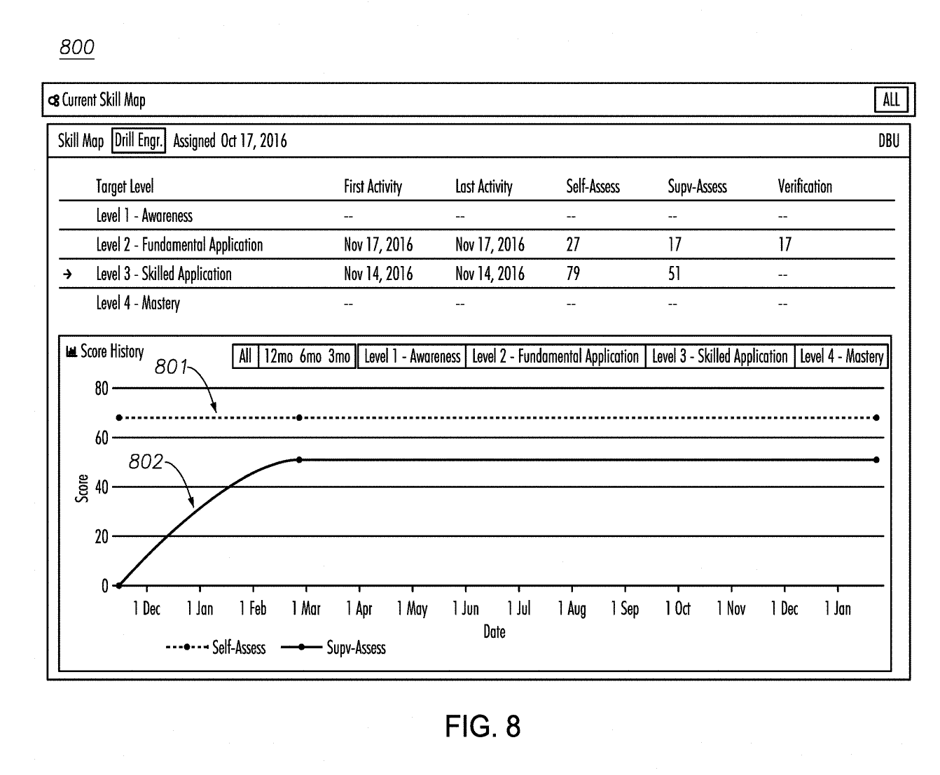

For example, FIG. 8 illustrates a graphical representation 800 of history data recorded by a History Module 250 in accordance with implementations of various techniques described herein. As shown, the history data corresponds to a drilling engineer skills map, which was assigned to an organizational member on Oct. 17, 2016. In addition, the data shows that the member was assigned a Competency Level 2 and a Competency Level 3. The graphical representation 800 shows the progress of the self-assessment and the supervisor assessment for the member with respect to the Competency Level 3. In particular, the representation 800 shows a self-assessment line 801 where the member achieved self-assessment competency score of 79 on Nov. 14, 2016. In addition, the representation 800 shows a supervisor assessment curve 802, where a supervisor determined the member's competency score is equal to 51. The assessment curve 802 indicates that the supervisor began the supervisor assessment on Nov. 14, 2016 and completed his assessment near Mar. 1, 2017.

As shown, the History Module 250 may be used to track the history, and the diligence, of the organizational members, supervisors, and/or verifiers with respect to the assessment process. In another implementation, the History Module 250 may be used to track the assessments of one or more candidates for hire by the organization.

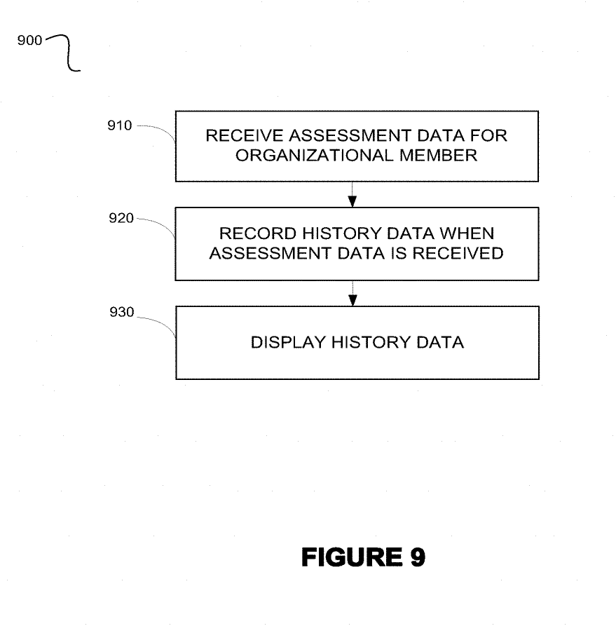

FIG. 9 illustrates a flow diagram of a method 900 for tracking an assessment history for an organizational member in accordance with implementations of various techniques described herein. In one implementation, method 900 may be at least partially performed by a computing system, such as the computing system 102 discussed above. It should be understood that while method 900 indicates a particular order of execution of operations, in some implementations, certain portions of the operations might be executed in a different order. Further, in some implementations, additional operations or steps may be added to the method 900. Likewise, some operations or steps may be omitted.

At block 910, the computing system may receive assessment data for the organizational member. In one implementation, the assessment data may include self-assessment data, a self-assessment competency score, supervisor assessment data, a supervisor assessment competency score, and/or verifier assessment data, as described above in the assessment stage.

At block 920, the computing system may record history data when the assessment data is received. The history data may be the date and/or time that the assessment data is received by the CMS 107. In one implementation, the history data may be recorded in real time.

At block 930, the computing system may display the history data. In one implementation, the computing system may display the history data graphically.

### 2. Risk Analysis

In one implementation, the Risk Analysis Module 242 may be used to determine a risk associated with an organizational unit and/or an organization as a whole based on one or more competency scores of organizational members. In particular, the organizational unit and/or the organization may be at risk of failure of organizational operations if a sufficient number of members fail to achieve minimum competency scores.

In particular, the Risk Analysis Module 242 may receive organizational data for the organization, including which members are assigned to each organizational unit. The Risk Analysis Module 242 may also receive self-assessment data, a self-assessment competency score, supervisor assessment data, a supervisor assessment competency score, and/or verifier assessment data for each organizational member for one or more skills and/or skills maps.

The Risk Analysis Module 242 may also receive risk data for the organization, where the risk data may include one or more risk levels associated with one or more ranges of competency scores. For example, a range of competency scores from 100 to 83 for a particular skill may indicate that there is a low risk of operational failure by a member or organizational unit. In another example, a range of competency scores from 62 to 38 for a particular skill may indicate that there is a manageable risk of operational failure by a member or organizational unit. The risk levels associated with each range of competency scores may be predetermined by a user or by the CMS 107. The risk data may also include development needs for each range of competency scores, and a color assigned to each range.

The Risk Analysis Module 242 may display the received self-assessment data, a self-assessment competency score, supervisor assessment data, a supervisor assessment competency score, and/or verifier assessment data, where this data may be arranged based on the received organizational data. For example, the various assessment data may be arranged by organizational member and by skill. In particular, the data may be displayed in a matrix format, hereinafter referred to as a risk matrix.

The Risk Analysis Module 242 may also display the colors associated with each organizational member's competency for each skill, where the colors are based on the competency score of the member and which range of scores applies to the member's score. In one implementation, the competency score displayed for each member may be the self-assessment competency score or the supervisor assessment competency score for a particular skill.

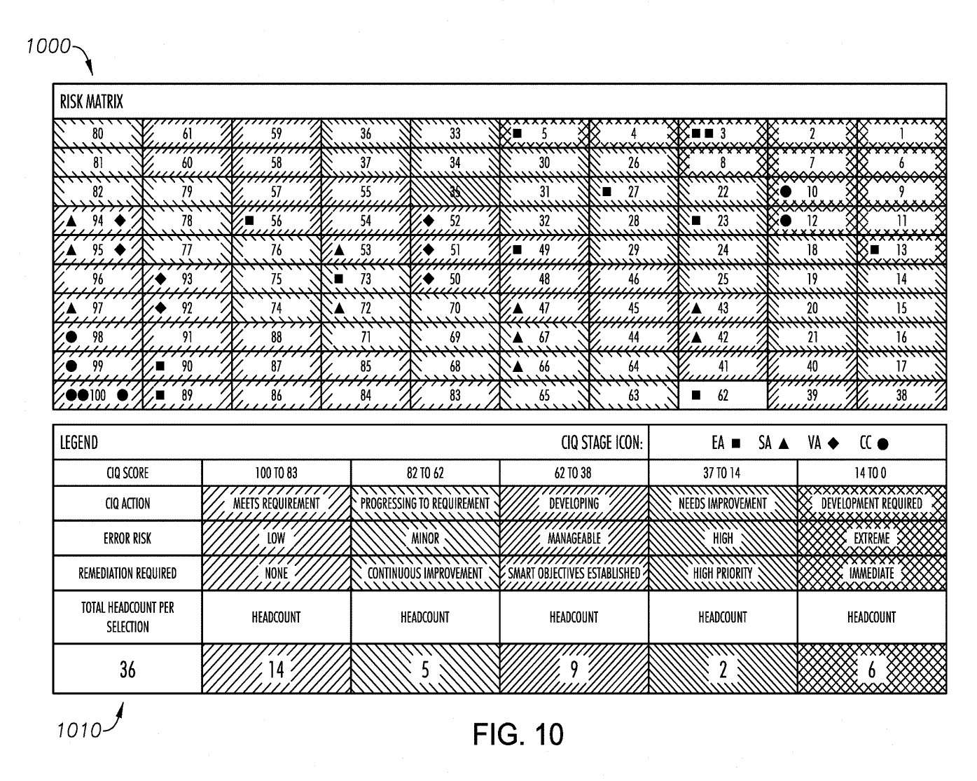

For example, FIG. 10 illustrates a graphical representation of a risk matrix 1000 for an organizational unit in accordance with implementations of various techniques described herein. As shown, the risk matrix 1000 includes a plurality of columns and rows. Each column may represent a different skill, and each row may represent a different organizational member of the unit. The competency scores for each member with respect to a particular skill are displayed in the risk matrix 1000. In addition, the matrix 1000 is color coded according to the legend 1010, which indicates different information for each range of competency scores. In particular, the legend 1010 indicates an error risk, a color, and a form of remediation required (i.e., development needs) that may apply for competency scores within the given range.

Upon displaying the risk matrix 1000, a user (e.g., an administrator or supervisor) may be able to view the risk to operations for an organizational unit for various skills. By viewing the risk matrix, particularly with the predetermined colors and development needs for each range, a user may be able to view a global risk picture for the organizational unit, and to determine if any organizational unit or team has a higher than normal likelihood of an incident based on cumulative competency gaps.

The risk matrix 1000 may provide a user with the ability to view organizational members against a predetermined risk matrix to increase visibility of risks by job function and assist management decision-making. In particular, the predetermined risk matrix may be represented by the received risk data, where the risk levels associated with each range of competency scores, the development needs for each range of competency scores, and a color assigned to each range may be predetermined by a user or by the CMS 107.

The risk matrix 1000 may also identify any immediate development needs based on competency gaps prior to operations taking place to avoid potential incidents. The risk matrix 1000 may further be used to produce organizational intelligence, which may be used to create risk mitigation plans for organizational units, teams or individuals to ensure safe operations.

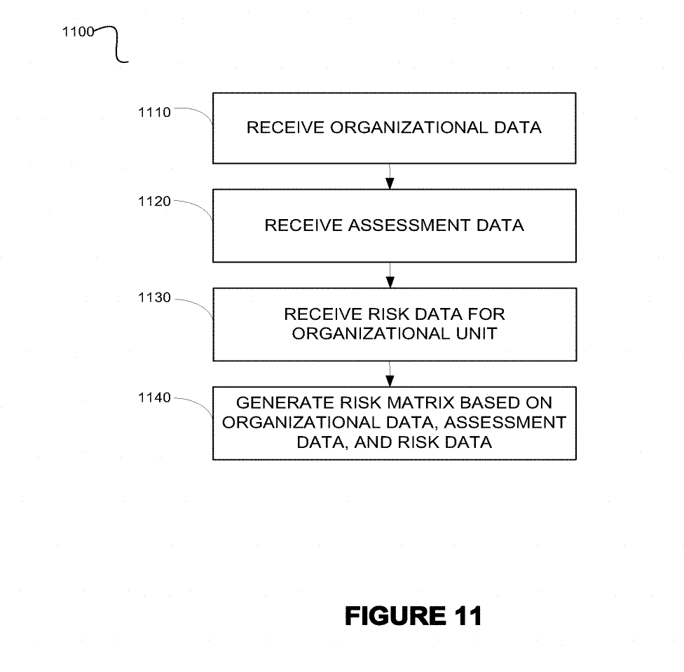

FIG. 11 illustrates a flow diagram of a method 1100 for generating a risk matrix for an organizational unit of an organization in accordance with implementations of various techniques described herein. In one implementation, method 1100 may be at least partially performed by a computing system, such as the computing system 102 discussed above. It should be understood that while method 1100 indicates a particular order of execution of operations, in some implementations, certain portions of the operations might be executed in a different order. Further, in some implementations, additional operations or steps may be added to the method 1100. Likewise, some operations or steps may be omitted.

At block 1110, the computing system may receive organizational data for the organization, including which organizational members are assigned to the organizational unit. In one implementation, the organizational data may be derived from the organizational database, as described above.

At block 1120, the computing system may receive assessment data for the organizational members of the organizational unit. In one implementation, the assessment data may include self-assessment data, a self-assessment competency score, supervisor assessment data, a supervisor assessment competency score, and/or verifier assessment data, as described above.

At block 1130, the computing system may receive risk data for the organizational unit, where the risk data may include one or more risk levels, one or more color coding options, and one or more development needs associated with one or more ranges of competency scores, where the risk data may be predetermined.

At block 1140, the computing system may generate a risk matrix 1000 based on the organizational data, the assessment data, and the predetermined risk data. In one implementation, each column of the matrix may represent a different skill, and each row of the matrix may represent a different organizational member of the unit. The competency scores for each member with respect to a particular skill may be displayed in the risk matrix.

### 3. Staffing

The Staffing Module 243 may be used to identify current and/or future competency gaps, and to aid in determining how to fix such competency gaps. In particular, the Staffing Module 243 may receive the self-assessment data, the self-assessment competency score, the supervisor assessment data, the supervisor assessment competency score, and/or the verifier assessment data for one or more skills for an organizational unit or the organization.

Based on this assessment data, the Staffing Module 243 may identify one or more current competency gaps among the members of the organizational unit or the organization. As noted above, a competency gap may exist for a particular skill if a self-assessment competency score or a supervisor assessment competency score is less than a targeted competency score for the skill.

The Staffing Module 243 may identify one or more training options that can be used to narrow the competency gaps for an organizational member. In addition, the Staffing Module 243 may identify a candidate among the one or more organizational members to replace the current organizational member having the competency gap for a particular skill, where these members may already have a self-assessment competency score or a supervisor assessment competency score that is greater than or equal to a minimum competency score for the skill. In some cases, these one or more organizational members may have a self-assessment competency score or a supervisor assessment competency score less than a minimum competency score, but still within a predetermined threshold of the minimum competency score.

If the Staffing Module 243 is not able to identify a candidate among the organizational members who can replace the current organizational member having the competency gap for a particular skill, the user of the Staffing Module 243 may decide to find a candidate from outside of the organization.

In addition, the Staffing Module 243 may keep track of future termination or retirement dates for current organizational members. The Staffing Module 243 may then identify future competency gaps that may occur upon reaching these termination or retirement dates. The Staffing Module 243 may identify a candidate among the one or more organizational members who could be promoted or be used to replace the current organizational member whose departure would cause the competency gap for a particular skill. If the Staffing Module 243 cannot identify a candidate among the organizational members, then a user of the Staffing Module 243 may decide to find a replacement from outside of the organization before the termination or retirement date.

As such, the Staffing Module 243 may allow for the ability to define and address staffing implications for strategic and operational plans. Staffing, in this context, may include all managed movement into, around, and out of an organization (e.g., recruitment, hiring, promotion, transfer, redeployment, attrition, retention, etc.), including organizational unit and/or global search per target level, per skill, by experience, by tenure, and/or by job function. In particular, the Staffing Module 243 may be used to make decisions regarding recruiting, hiring, promotion, transfer, and/or redeployment of organizational member.

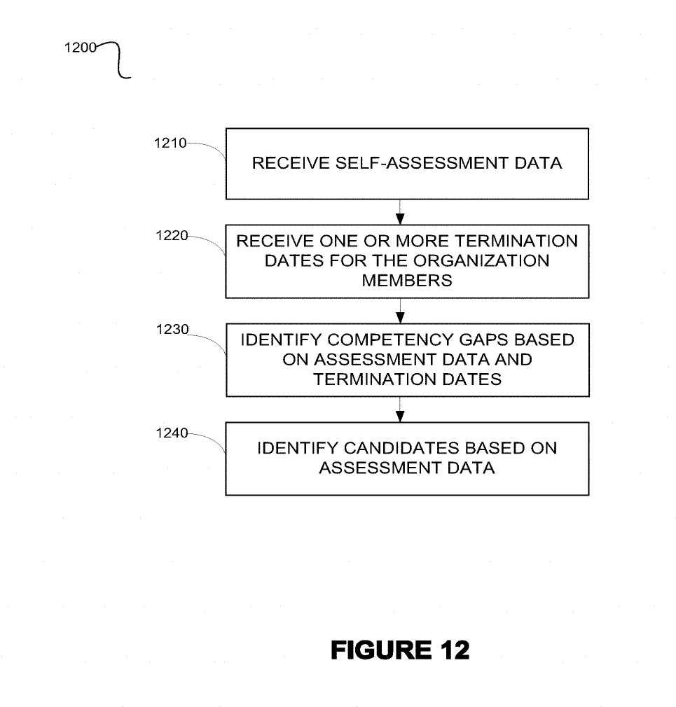

FIG. 12 illustrates a flow diagram of a method 1200 for staffing an organization in accordance with implementations of various techniques described herein. In one implementation, method 1200 may be at least partially performed by a computing system, such as the computing system 102 discussed above. It should be understood that while method 1200 indicates a particular order of execution of operations, in some implementations, certain portions of the operations might be executed in a different order. Further, in some implementations, additional operations or steps may be added to the method 1200. Likewise, some operations or steps may be omitted.

At block 1210, the computing system may receive assessment data for organizational members of the organization. In one implementation, the assessment data may include self-assessment data, a self-assessment competency score, supervisor assessment data, a supervisor assessment competency score, and/or verifier assessment data for organizational members for an organization unit or the organization as a whole.

At block 1220, the computing system may receive one or more termination dates for the organizational members. The termination dates may include retirement dates or any date after which an organizational member may leave the organization.

At block 1230, the computing system may identify one or more competency gaps based on the assessment data and the one or more termination dates. As noted above, the competency gaps may be current or may occur on a future date.

At block 1240, the computing system may identify one or more candidates based on the assessment data. In such an implementation, the candidates may be current members of the organization.

### 4. Pre-Assessment

A Pre-Assessment Module 244 may be used to evaluate candidates prior to an organization making member hiring decisions. This module may be part of or may be used in conjunction with the Staffing Module 243. In particular, for potential organizational members, this Pre-Assessment Module 244 may offer a candidate access to a self-assessment portion of the CMS 107 before offering an interview. The self-assessment portion may involve a subset of skills from a current skills map, whose elements may include the use of narrative answers to be compared with predictable measurement answers.

The Pre-Assessment Module 244 may generate a pre-assessment skills map, where this skills map may include a subset of skill elements from one or more skills of a current skills map. In one implementation, the pre-assessment skills map may include one or more skills for which a competency gap has been identified in the organization. In this manner, the pre-assessment skills map includes one or more skills for which a current opening exists among the organizational members.

Further, the Pre-Assessment Module 244 may be used to transmit the pre-assessment skills map to one or more candidates, such as by providing temporary login information for the CMS 107 and/or a hyperlink to the pre-assessment skills map via email. Candidates may be given access to the pre-assessment skills map for a restricted period (e.g., 48 hours). Thereafter, access may be terminated and all data is saved and accessible for evaluation by the organization's hiring team (e.g., supervisors).

In response to the pre-assessment skills map, the one or more candidates may provide candidate self-assessment data. The candidate self-assessment data may include any evidence corresponding to the evidence requirements for the skill elements of the pre-assessment skills map. For example, the candidate self-assessment data may include any evidence needed to complete the skill elements of the pre-assessment skills map, including a simple confirmation, narrative answer, and/or the like. Further, the Pre-Assessment Module 244 may automatically send an email notice with profile link to designated hiring team members when the candidate self-assessment data is available for review.

The supervisors or hiring team may perform a hiring assessment based on the candidate self-assessment data for the one or more candidates. For each candidate and each skill element, the supervisors may review the candidate self-assessment data submitted. Based on the candidate self-assessment data, the supervisors may confirm or deny that the candidate is competent with respect to the skill elements (i.e., capable of performing the task or providing the information described in the skill elements), where this confirmation or denial may be referred to as hiring assessment data.

For example, the candidate may have provided a narrative answer as candidate self-assessment data, where the answer is to be compared with a predictable measurement answer. The supervisors may then view the narrative answer and the predictable measurement answer, compare them, and then determine whether the narrative answer sufficiently matches the predictable measurement answer. If they match, then the supervisors may confirm the candidate's capability of performing the task or providing the information described in the skill element. If they do not match, then the supervisors may deny that the candidate is capable of performing the task or providing the information described in the skill element.

This process may be repeated for each candidate submitting the candidate self-assessment data. Upon completing the hiring assessments for the skill elements of the assigned skills map, the CMS 107 may determine one or more candidate assessment competency scores for each of the candidates. These scores may be determined in the same manner as described above for determining a supervisor assessment competency score or a self-assessment competency score. In addition, the Pre-Assessment Module 244 may rank each candidate based on his respective candidate assessment competency score.

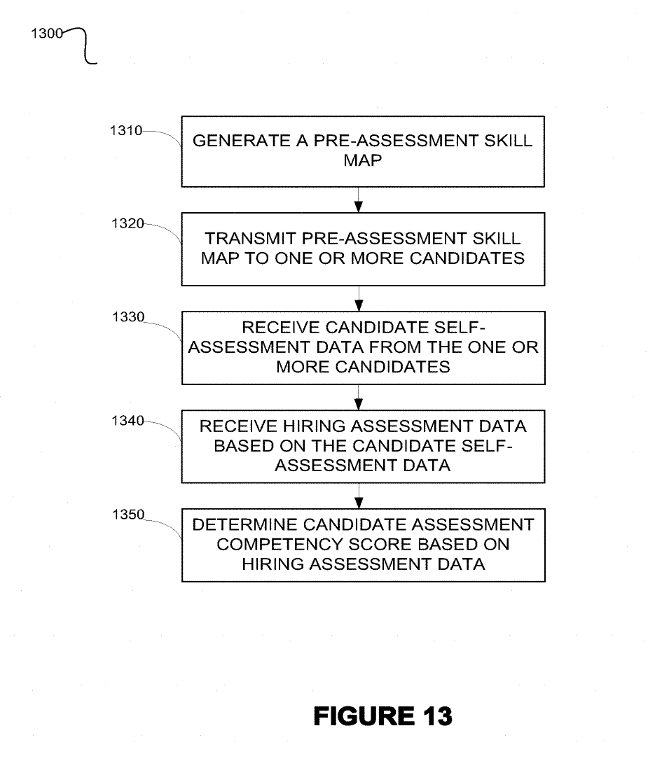

FIG. 13 illustrates a flow diagram of a method 1300 for performing a pre-assessment of a candidate for an organization in accordance with implementations of various techniques described herein. In one implementation, method 1300 may be at least partially performed by a computing system, such as the computing system 102 discussed above. It should be understood that while method 1300 indicates a particular order of execution of operations, in some implementations, certain portions of the operations might be executed in a different order. Further, in some implementations, additional operations or steps may be added to the method 1300. Likewise, some operations or steps may be omitted.

At block 1310, the computing system may generate a pre-assessment skills map, where this skills map includes a subset of skill elements from one or more skills of a current skills map. In one implementation, the pre-assessment skills map may include one or more skills for which a competency gap has been identified in the organization.

At block 1320, the computing system may transmit the pre-assessment skills map to one or more candidates. For example, the computing system may transmit the skills map by providing temporary login info for the CMS 107 and/or a hyperlink to the pre-assessment skills map via email.

At block 1330, the computing system may receive candidate self-assessment data from the one or more candidates. The candidate self-assessment data may include any evidence corresponding to the evidence requirements for the skill elements of the pre-assessment skills map.

At block 1340, the computing system may receive hiring assessment data based on the candidate self-assessment data. In one implementation, based on the candidate self-assessment data, supervisors may confirm or deny that the candidate is capable of performing the task or providing the information described in the skill element, where this confirmation or denial may be referred to as the hiring assessment data.

At block 1350, the computing system may determine a candidate assessment competency score based on the hiring assessment data.

### 5. Knowledge

A Knowledge Module 245 may be used to share knowledge within an organization via questions provided to and answered by specific organizational members. These organizational members may be those who, after the verifier assessment, achieve a competency score greater than a predetermined number (e.g., 99) for a particular skill at a particular competency level. In particular, the predetermined number may be equal to a maximum competency score, and the particular competency level may be a competency level representing the most advanced level of mastery of the skill possible in the CMS 107.

In particular, the Knowledge Module 245 may be used to identify and invite these members to access the Knowledge Module 245 as a subject matter expert (SME). Collectively, they may be referred to as a SME group for a particular skill.

For example, the Knowledge Module 245 may identify and invite such members to the SME group, where the group may be composed of up to maximum number of SMEs (e.g., six) who have achieved a competency score (after the verifier assessment) of 100 for a Competency Level 4 for a particular skill. All organizational members may have access to search the community or ask questions regarding that particular skill to the SME group via the Knowledge Module 245.

The SME group may provide the answers to the questions via the Knowledge Module 245, with the answers viewable by the organization. An analysis of the questions and answers may also be used to improve the skills library and to improve learning within the organization, such as by identifying common or frequent gaps in competency within the organization. Learning materials, policies, and procedures may be created or amended based on such an analysis.

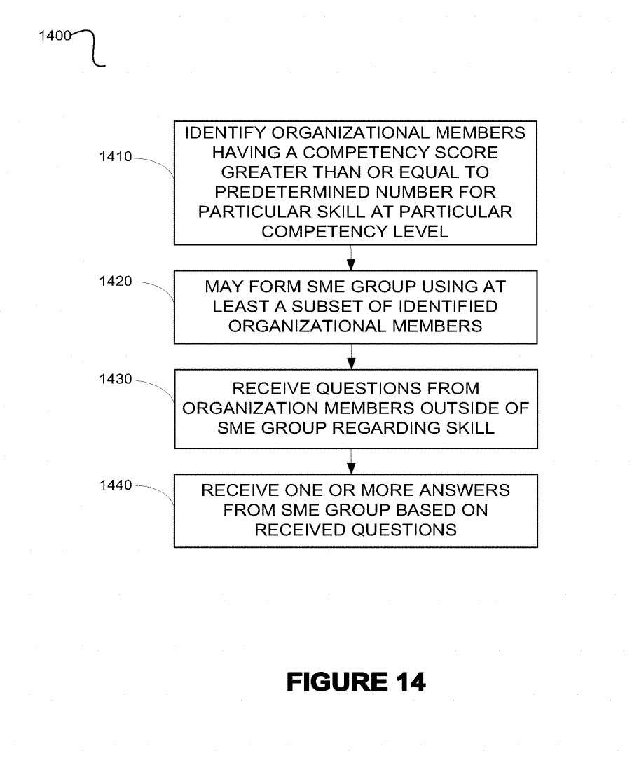

FIG. 14 illustrates a flow diagram of a method 1400 for using a subject matter expert (SME) group for an organization in accordance with implementations of various techniques described herein. In one implementation, method 1400 may be at least partially performed by a computing system, such as the computing system 102 discussed above. It should be understood that while method 1400 indicates a particular order of execution of operations, in some implementations, certain portions of the operations might be executed in a different order. Further, in some implementations, additional operations or steps may be added to the method 1400. Likewise, some operations or steps may be omitted.

At block 1410, the computing system may identify one or more organizational members of the organization having a competency score, after a verifier assessment, that is greater than or equal to a predetermined number for a particular skill at a particular competency level. For example, the computing system may identify one or more organizational members having a competency score, after a verifier assessment, that is greater than or equal to 99 for a skill at a Competency Level 4. In one implementation, the organizational members may have supplied a narrative answer for comparison to a predictable measurement answer in order to achieve the competency score.

At block 1420, the computing system may form the SME group using at least a subset of the identified organizational members. For example, the computing system may form the SME group of up to six of the identified members.

At block 1430, the computing system may receive one or more questions from organizational members outside of the SME group regarding the particular skill. The questions may be viewable by the all organizations members of the organization.

At block 1440, the computing system may receive one or more answers from the SME group based on the received questions. The answers may be viewable by the all organizations members of the organization.

### 6. Exposure Levels

As explained above, during the assessment stage, a supervisor assessment competency score for the skill may not match the self-assessment competency score for the skill. In particular, the supervisor assessment competency score may be less than a targeted competency score for the skill. In such a case, the supervisor may assign one or more training options to the organizational member to improve the member's competency with respect to a particular skill element of the skill.

In one implementation, the Training Module 222 may be used by an organizational member to access the training options (e.g., learning references, classroom courses, books/manuals, policies, procedures, online references, recommendations for on the job training, and/or online learning) associated with a skill element. The Training Module 222 may include the CBD Module and the CPO Module. In particular, the CBD Module may allow for the viewing of potential learning activities to assist in bridging competency gaps identified during the supervisor assessment, and then transferring these activities to the CPO Module to create one or more development objectives. The CPO Module may be configured to prioritize competency gaps against targeted learning activities against completion dates.

As such, the training options for an organizational member may be prioritized by the supervisor or may be set via the Training Module 222, the CBD Module, and/or the CPO Module. The organizational member's actual day-to-day experience may expose him to skills, skill units, and/or skill elements for which specific training options are needed. However, a development list of training options, as set by the supervisor or Training Module 222, may not place a high priority for the specific training options that correspond to these skills, skill units, and/or skill elements.

As such, the organizational member may wish to reprioritize the development list such that the skills, skill units, and/or skill elements to which the member is exposed may correspond to the first training options utilized. For example, the organizational member may indicate to the Exposure Levels Module 246 the level of frequency at which he is exposed to a particular skill, such as daily, weekly, monthly, or annually. Based on this level of exposure, the Exposure Levels Module 246 may reprioritize the training options for the organizational member.

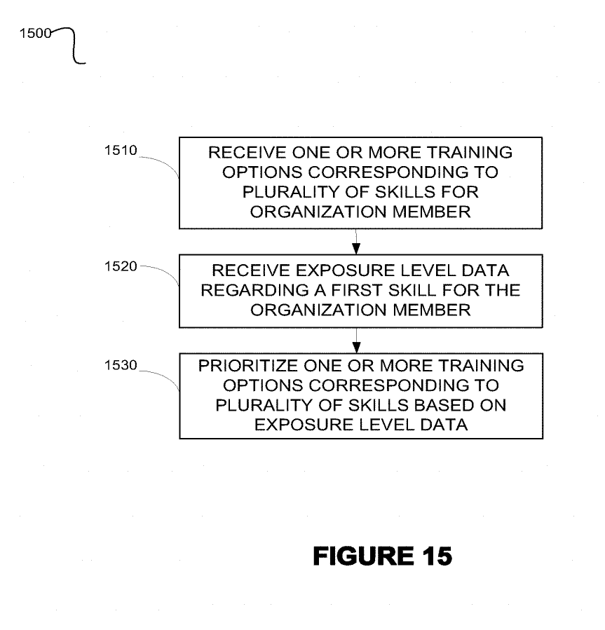

FIG. 15 illustrates a flow diagram of a method 1500 for prioritizing one or more training options for a skill based on an exposure level in accordance with implementations of various techniques described herein. In one implementation, method 1500 may be at least partially performed by a computing system, such as the computing system 102 discussed above. It should be understood that while method 1500 indicates a particular order of execution of operations, in some implementations, certain portions of the operations might be executed in a different order. Further, in some implementations, additional operations or steps may be added to the method 1500. Likewise, some operations or steps may be omitted.

At block 1510, the computing system may assign one or more training options corresponding to a plurality of skills to an organizational member, where the training options may be prioritized based on a supervisor assessment. The supervisor may assign one or more training options to the organizational member to improve the member's competency with respect to a number of skills.

At block 1520, the computing system may receive exposure level data regarding a first skill of the plurality of skills for the organizational member. The exposure level data may indicate a level of frequency at which the member is currently exposed to the first skill, such as daily, weekly, monthly or annually.

At block 1530, the computing system may prioritize the one or more training options corresponding to the plurality of skills based on the exposure level data. In particular, the computing system may prioritize the training options such that the training options corresponding to the first skill have a higher priority on a development list.

### 7. Report Authentication

In one implementation, one or more reports may be generated by the CMS 107 based on the one or more competency scores generated during the assessment stage for the organization, one or more organization units, and/or one or more organizational members. The reports may include a summary of the competency scores and/or other assessment data generated during the assessment stage.

The Report Authentication Module 247 may be used to ensure or verify authenticity of the competency scores and information within the report. In particular, the Report Authentication Module 247 may assign a unique, embedded Quick Response (QR) code to be included or embedded on each report (e.g., a hard copy of the report), where a scan of the QR code will indicate that the report is a valid report from the CMS 107 and contains accurate information.

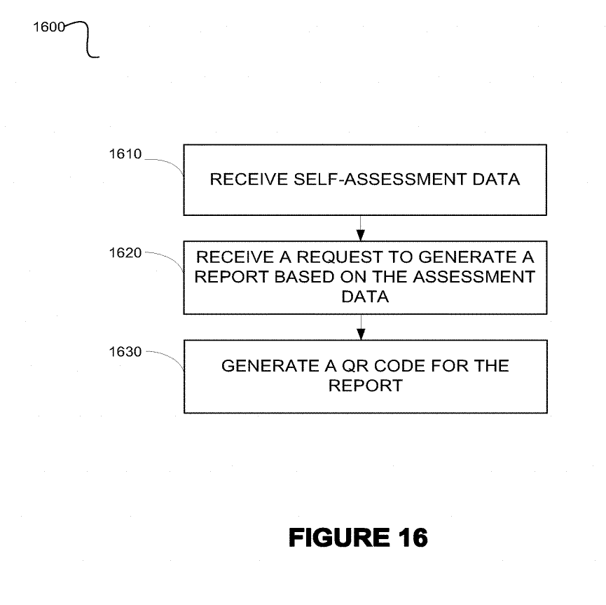

FIG. 16 illustrates a flow diagram of a method 1600 for authenticating a report from a CMS in accordance with implementations of various techniques described herein. In one implementation, method 1600 may be at least partially performed by a computing system, such as the computing system 102 discussed above. It should be understood that while method 1600 indicates a particular order of execution of operations, in some implementations, certain portions of the operations might be executed in a different order. Further, in some implementations, additional operations or steps may be added to the method 1600. Likewise, some operations or steps may be omitted.

At block 1610, the computing system may receive assessment data for organizational members of the organization. The assessment data may include self-assessment data, a self-assessment competency score, supervisor assessment data, a supervisor assessment competency score, and/or verifier assessment data for organizational members of an organization unit or the organization as a whole.

At block 1620, the computing system may receive a request to generate a report based on the assessment data. The report may include information on the one or more competency scores generated during the assessment stage for the organization, one or more organization units, and/or one or more organizational members.

At block 1630, the computing system may generate a QR code for the report. In particular, the code may be a unique, embedded QR code to be included on the report (e.g., a hard copy of the report), where a scan of the QR code will indicate that the report is a valid report from the computing system and contains accurate information.

At block 1640, the computing system may generate the report with the QR code.

### 8. Member Authentication

In one implementation, the Member Authentication Module 251 may assign a unique QR code to each organizational member. A supervisor can scan the code, such as on a badge worn by the organizational member, to receive a competency report on the organizational member, including the various competency levels demonstrated by the organizational member. In this manner, the supervisor can quickly access the member's profile page by scanning the QR code, from which the supervisor can access the member's competency scores, skills maps, and/or the like.

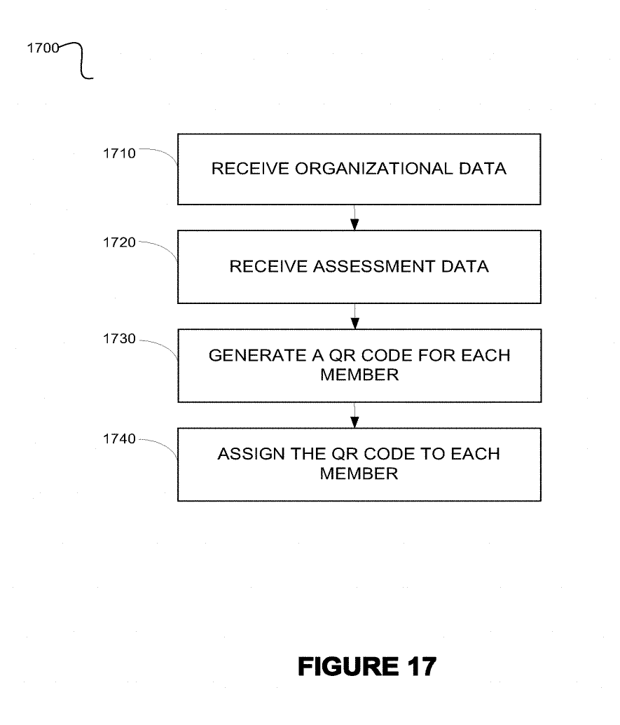

FIG. 17 illustrates a flow diagram of a method 1700 for assigning a QR code to an organizational member in accordance with implementations of various techniques described herein. In one implementation, method 1700 may be at least partially performed by a computing system, such as the computing system 102 discussed above. It should be understood that while method 1700 indicates a particular order of execution of operations, in some implementations, certain portions of the operations might be executed in a different order. Further, in some implementations, additional operations or steps may be added to the method 1700. Likewise, some operations or steps may be omitted.

At block 1710, the computing system may receive organizational data for the organization, including which members are assigned to each organizational unit. In one implementation, the organizational data may be derived from the organizational database, as described above.

At block 1720, the computing system may receive assessment data for each member with respect to one or more competency levels. The assessment data may include self-assessment data, a self-assessment competency score, supervisor assessment data, a supervisor assessment competency score, and/or verifier assessment data, as described above.

At block 1730, the computing system may generate a QR code for each member. In particular, the computing system may assign a unique QR code to each organizational member.

At block 1740, the computing system may assign the QR code to each member. In operation, a supervisor can scan the code, such as on a badge worn by the organizational member, to receive a competency report regarding the assessment data of an organizational member or to access a member's profile page.

### 9. Social Media

The Social Media Module 248 may be used by an organizational member to link his or her social media profile to the CMS 107, and may include the ability for a supervisor to endorse a skill of the CMS 107 to the organizational member's social media profile via a network (e.g., via the internet). The endorsement may be made by the supervisor's social media profile. If the supervisor does not have a social media profile, it may appear on an organizational member's social media profile as an endorsement from the CMS 107 or from the organization.

In particular, after the verifier assessment, organizational members (e.g., SMEs) may be eligible to communicate to their social media profiles that they have demonstrated a competency score greater than a predetermined value with respect to one or more skills. The Social Media Module 248 may automatically upload the skill name to a member's social media profile, and may include a CMS icon as an element of the skill endorsement, unless the supervisor is used as the one providing the endorsement. For example, the social media profile may be a professional networking account, a LinkedIn account, and/or the like.

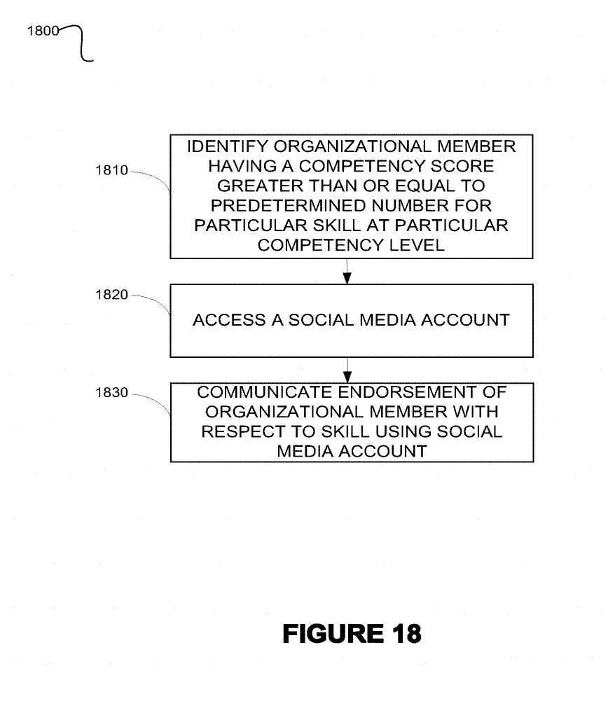

FIG. 18 illustrates a flow diagram of a method 1800 for endorsing a skill via social media in accordance with implementations of various techniques described herein. In one implementation, method 1800 may be at least partially performed by a computing system, such as the computing system 102 discussed above. It should be understood that while method 1800 indicates a particular order of execution of operations, in some implementations, certain portions of the operations might be executed in a different order. Further, in some implementations, additional operations or steps may be added to the method 1800. Likewise, some operations or steps may be omitted.

At block 1810, the computing system may identify an organizational member having a competency score, after a verifier assessment, which is greater than or equal to a predetermined number for a particular skill at a particular competency level. For example, the organizational member may have achieved a competency score, after a verifier assessment, that is greater than or equal to 99 for a skill at a Competency Level 4.

At block 1820, the computing system may access a social media account. In one implementation, the social media account may belong to a supervisor involved in the member's supervisor assessment. In another implementation, the social media account may belong to the organization.

At block 1830, the computing system may communicate an endorsement of the organizational member with respect to the skill using the social media account. This functionality may automatically upload the skill name to a member's social media profile using the account, and may include a CMS icon as an element of the skill endorsement, unless the supervisor is the one providing the endorsement.

### 10. Equipment

The Equipment Module 249 may be used to account for equipment, including personal protection equipment (PPE), assigned to an organizational member. The module may keep track of equipment pieces assigned to each organizational member, may keep track of the expiration dates for the equipment, and may order equipment automatically when equipment has expired or will expire soon. Such equipment pieces may include, but are not limited to, hard hats, air monitors, and respiratory masks.

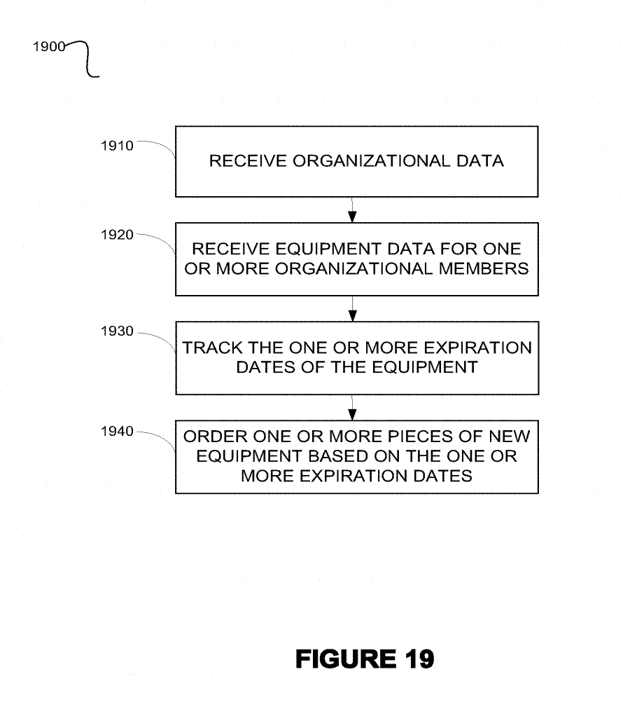

FIG. 19 illustrates a flow diagram of a method 1900 for managing equipment in accordance with implementations of various techniques described herein. In one implementation, method 1900 may be at least partially performed by a computing system, such as the computing system 102 discussed above. It should be understood that while method 1900 indicates a particular order of execution of operations, in some implementations, certain portions of the operations might be executed in a different order. Further, in some implementations, additional operations or steps may be added to the method 1900. Likewise, some operations or steps may be omitted.

At block 1910, the computing system may receive organizational data for the organization, including data regarding one or more organizational members of the organization. In one implementation, the organizational data may be derived from the organizational database, as described above.

At block 1920, the computing system may receive equipment data for the one or more organizational members. In particular, the equipment data may include any data relating to one or more pieces of equipment, including personal protection equipment (PPE), assigned to one or more organizational members. Such data may include expiration dates for the equipment.

At block 1930, the computing system may track the one or more expiration dates of the equipment for the one or more organizational members based on the equipment data.

At block 1940, the computing system may order one or more pieces of new equipment based on the one or more expiration dates. In particular, the computing system may order the new equipment if a current date is within a predetermined number of days of an expiration date.

### 11. Other Modules

Other analysis stage modules 240 of the CMS 107 not described above may also be used to analyze individual, team, and organizational competency information obtained during the assessment stage.

In one implementation, the analysis stage modules 240 may include a Dashboard Module 241. The Dashboard Module 241 may use assessment data to populate a dynamic dashboard at an administrative, global, and local level, where the assessment data may be viewed via a Dashboard Module 241. One or more organizational members can view and analyze real-time individual, team, and organizational competency data through comprehensive, dynamic filtering dashboards and reports. The assessment data accessible via the dashboard may inform and support decisions on recruitment, retention, development, succession and member moves, essentially providing organizational intelligence to better manage people resources. The Dashboard Module 241 may include the ability to view ad-hoc teams within an organizational unit, including job functions for analyzing assessment data between units.

From the Dashboard Module 241, a skills matrix may be produced. The skills matrix may display all organizational members associated with the organization, with an organizational unit, or with a particular position within the organization. For each organizational member, the matrix may show a target competency level, progress levels for a skills map for the organizational member and the supervisor, the current stage in the assessment process, and the achieved competency level for each skill. The levels and/or progress displayed may be shown in conjunction with a color to better indicate the competency of the organizational member. The matrix may also show an average level for each skill among the listed organizational members, and may provide a summary for the organizational member competency levels. In particular, the skills matrix may be generated using a Skill Matrix Module, which may allow for the identification of member strengths and challenges against each skill within a skills map associated with a job function.

In addition, a heat map may be produced from the Dashboard Module 241. The heat map may display all organizational members associated with the organization, with a business unit, or with a particular position within the organization. For each organizational member, the map may show a target competency level, progress levels for a skills map for the organizational member and the supervisor, the current stage in the assessment process, and the achieved competency score for each skill. The map may also show an average competency score for each skill among the listed organizational members.

In addition, the analysis stage modules 240 may include a Dashboard Analytics Module, which may allow for the viewing of employee data via a dashboard user interface for global, organizational unit, manager, and supervisor purposes. The Dashboard Analytics Module may include privacy lock functionality, which can be switched on when needed to hide the identity of employees' names during presentations. The Dashboard Analytics Module may also allow for the viewing of all ad-hoc teams within an organizational unit, including job functions to analyze assessment data between groups. The analysis stage modules 240 may also include a Quick Links Module, which may allow for the ability to print reports though a one-click portlet on the global or organizational unit dashboards and the member profiles. The analysis stage modules 240 may also include a Software Analytics Module, which may be used to view real-time user analysis of the CMS 107, including, but not limited to, user location, module views, browsers used, operating systems, and screen sizes. The analysis stage modules 240 may also include a Heat Map Color and Range Designer Module, which has the ability to customize the heat map colors and ranges via an administration portlet. The analysis stage modules 240 may also include a Voluntary & Archived Competency Standard Module, which provides the capability for a user to voluntarily assess their skills against a skills map that is not required for their current position. The analysis stage modules 240 may include a Feedback Flagging Alerts Module, which may allow for a member to visibly notice feedback to a skills map, skill, skill unit, and/or skill element, such as through a series of flags of varying colors and where each color signifies different feedback. The analysis stage modules 240 may include a Multi-Target Module, which may be used to assign different competency level targets against each skill within a skills map assigned to a job function. The analysis stage modules 240 may include a Focused Assessment Module, which may be used to view only the target level elements per unit, and a Forced Assessment Module, which may be used to force an employee to the level below a target due to not meeting a threshold. The analysis stage modules 240 may include an Export Skill Matrix Module, which may be used to export the skill matrix to a spreadsheet file format and/or a Portable Document Format (PDF) via the portlet toolbar.

The analysis stage modules 240 may further include a Skills Map Completion Analytics Module, which may include the ability to view average time completion per each skills map assigned to each job function. The analysis stage modules 240 may include a Customized Dashboard Module, which may include the ability to customize any dashboard by adding or deleting portlets including moving portlets to an area of choice. The analysis stage modules 240 may include a Customized PDF Reports Module, which may include the ability to generate a customized PDF report by selecting data tables from a master PDF Database including the ability to save custom reports and self-send on chosen dates (i.e., monthly reports). The analysis stage modules 240 may include an Attainment Certification Module, which may include the ability to create certificates of attainment for employees against skills which have a competency score greater than 80. These certificates may be automatically generated by the software containing the BITMAP signatures of management including a disclaimer statement. An administration interface may be built to switch this functionality on and to custom design the certificates with a client's logo.

Further, the analysis stage modules 240 may include various other modules that may increase competency and management of a company, such as mentorship modules, continuing education modules, and the like. As shown above, the analysis stage modules 240 may be used for data visualization, which may enable fast identification of critical gaps and potential risks. Real-time data views in this stage may provide organizational competency status information from a global level down to a team level, and may include drill down capabilities that quickly yield trends and gaps. Further, organizations can be modeled by function or by business value chain using the CMS 107 in this stage. Managers and executives can have reliable insights into the capabilities of their respective teams as well as teams they may acquire. Further, users can use real-time queries and reports to search skill matches and look for potential mentors across the organization who possess specific skills or sets of skill, employees can look at their current career path as well as alternative potential career paths that they may want to consider, and managers can search for people with specific skills at specific levels. The CMS 107 lifecycle workflow may provide the capability of an organization to look at a multitude of roles needed across a product or service lifecycle, and identify and/or predict the competency gaps that may prevent the organization from successfully delivering its products and/or services.

As shown above, the analysis stage modules 240 may be used to analyze individual, team, and organizational competency information obtained during the assessment stage. In particular, the analysis stage modules 240 may use the assigned skills maps, the self-assessment data, the self-assessment scores, the supervisor assessment data, the supervisor assessment competency scores (whether finalized by the CMS 107 or not), and/or the verifier assessment data to analyze competencies for organizational members and/or organizational units.

In view of the above-described implementations, the CMS 107 may be used to evaluate an organization's capability, particularly regarding the competency levels of individuals, teams, and the overall organization through assessment, verification, and analysis. In particular, the CMS 107 may be used by organizations to model and evaluate competencies by business function or across a full business value chain. A value chain approach to competency modeling may facilitate visibility and better alignment of competencies across an organization. The CMS 107 may also incorporate the use of standardized measures (i.e., a predictable measurement answer) to objectively gauge competencies, and may include other modules that provide a picture of an organization's capabilities. Further, the CMS 107 may allow organizations to view and track competencies at the individual, team, functional and/or enterprise level using various assessment and analysis modules.

### III. Computing System

Various implementations of computing systems are further discussed below, including the computing system 102 of FIG. 1. Implementations of various technologies described herein may be operational with numerous general purpose or special purpose computing system environments or configurations. Examples of well-known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, augmented reality devices, smart phones, smart watches, personal wearable computing systems networked with other computing systems, tablet computers, and distributed computing environments that include any of the above systems or devices, and the like.

The various technologies described herein may be implemented in the general context of computer-executable instructions, such as program modules, being executed by a computer. Generally, program modules include routines, programs, objects, components, data structures, etc. that perform particular tasks or implement particular abstract data types. While program modules may execute on a single computing system, it should be appreciated that, in some implementations, program modules may be implemented on separate computing systems or devices adapted to communicate with one another. A program module may also be some combination of hardware and software where particular tasks performed by the program module may be done either through hardware, software, or both.

The various technologies described herein may also be implemented in distributed computing environments where tasks are performed by remote processing devices that are linked through a communications network, e.g., by hardwired links, wireless links, or combinations thereof. In a distributed computing environment, program modules may be located in both local and remote computer storage media including memory storage devices.

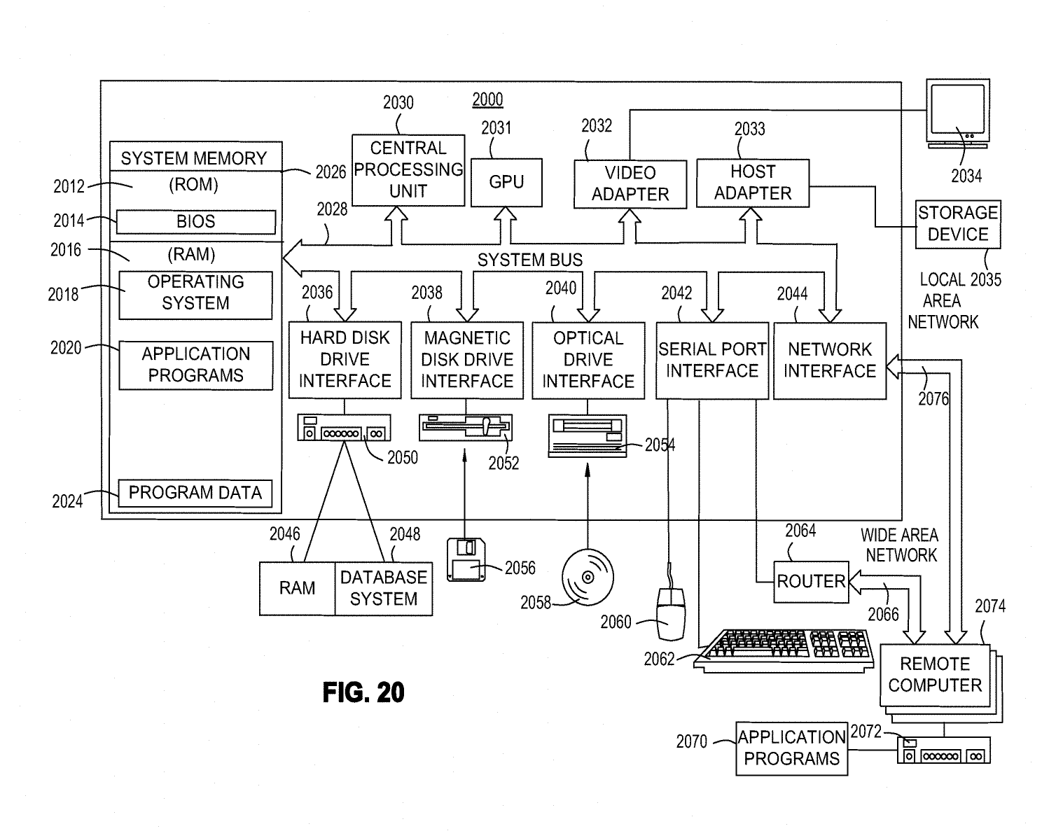

FIG. 20 illustrates a schematic diagram of a computing system 2000 in which the various technologies described herein may be incorporated and practiced. Although the computing system 2000 may be a conventional desktop or a server computer, as described above, other computer system configurations may be used.

The computing system 2000 may include a central processing unit (CPU) 2030, a system memory 2026, a graphics processing unit (GPU) 2031 and a system bus 2028 that couples various system components including the system memory 2026 to the CPU 2030. As such, the processor 104 of FIG. 1 may be similar to the CPU 2030. Although one CPU is illustrated in FIG. 20, it should be understood that in some implementations the computing system 2000 may include more than one CPU. The GPU 2031 may be a microprocessor specifically designed to manipulate and implement computer graphics. The CPU 2030 may offload work to the GPU 2031. The GPU 2031 may have its own graphics memory, and/or may have access to a portion of the system memory 2026. As with the CPU 2030, the GPU 2031 may include one or more processing units, and the processing units may include one or more cores. The system bus 2028 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 2026 may include a read-only memory (ROM) 2012 and a random-access memory (RAM) 2046. A basic input/output system (BIOS) 2014, containing the basic routines that help transfer information between elements within the computing system 2000, such as during start-up, may be stored in the ROM 2012.

The computing system 2000 may further include a hard disk drive 2050 for reading from and writing to a hard disk, a magnetic disk drive 2052 for reading from and writing to a removable magnetic disk 2056, and an optical disk drive 2054 for reading from and writing to a removable optical disk 2058, such as a CD ROM or other optical media. The hard disk drive 2050, the magnetic disk drive 2052, and the optical disk drive 2054 may be connected to the system bus 2028 by a hard disk drive interface 2056, a magnetic disk drive interface 2058, and an optical drive interface 2050, respectively. The drives and their associated computer-readable media may provide nonvolatile storage of computer-readable instructions, data structures, program modules and other data for the computing system 2000.

Although the computing system 2000 is described herein as having a hard disk, a removable magnetic disk 2056 and a removable optical disk 2058, it should be appreciated by those skilled in the art that the computing system 2000 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 2000. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. The computing system 2000 may also include a host adapter 2033 that connects to a storage device 2035 via a small computer system interface (SCSI) bus, a Fiber Channel bus, an eSATA bus, or using any other applicable computer bus interface. Combinations of any of the above may also be included within the scope of computer readable media. As such, the memory 106 of FIG. 1 may be similar to any of the above-described computer readable media.

A number of program modules may be stored on the hard disk 2050, magnetic disk 2056, optical disk 2058, ROM 2012 or RAM 2016, including an operating system 2018, one or more application programs 2020, program data 2024, and a database system 2048. The application programs 2020 may include various mobile applications (“apps”) and other applications configured to perform various methods and techniques described herein, such as the applications 108 of FIG. 1. The operating system 2018 may be any suitable operating system that may control the operation of a networked personal or server computer, such as VVindows® XP, Mac OS® X, Unix-variants (e.g., Linux® and BSD®), and the like.

A user may enter commands and information into the computing system 2000 through input devices such as a keyboard 2062 and pointing device 2060. Other input devices may include a microphone, joystick, game pad, satellite dish, scanner, or the like. These and other input devices may be connected to the CPU 2030 through a serial port interface 2042 coupled to system bus 2028, but may be connected by other interfaces, such as a parallel port, game port or a universal serial bus (USB). A monitor 2034 or other type of display device may also be connected to system bus 2028 via an interface, such as a video adapter 2032. In addition to the monitor 2034, the computing system 2000 may further include other peripheral output devices such as speakers and printers.

Further, the computing system 2000 may operate in a networked environment using logical connections to one or more remote computers 2074. The logical connections may be any connection that is commonplace in offices, enterprise-wide computer networks, intranets, and the Internet, such as local area network (LAN) 2056 and a wide area network (WAN) 2066. The remote computers 2074 may be another computer, a server computer, a router, a network PC, a smart device, a tablet, a laptop, a peer device or other common network node, and may include many of the elements described above relative to the computing system 2000. The remote computers 2074 may also each include application programs 2070 similar to that of the computer action function. As such, the remote devices 114 of FIG. 1 may be similar to the remote computers 2074.

When using a LAN networking environment, the computing system 2000 may be connected to the local network 2076 through a network interface or adapter 2044. When used in a WAN networking environment, the computing system 2000 may include a router 2064, wireless router or other means for establishing communication over a wide-area network 2066, such as the Internet. The router 2064, which may be internal or external, may be connected to the system bus 2028 via the serial port interface 2052. In a networked environment, program modules depicted relative to the computing system 2000, or portions thereof, may be stored in a remote memory storage device 2072. It will be appreciated that the network connections shown are merely examples and other means of establishing a communications link between the computers may be used.

The network interface 2044 may also utilize remote access technologies (e.g., Remote Access Service (RAS), Virtual Private Networking (VPN), Secure Socket Layer (SSL), Layer 2 Tunneling (L2T), or any other suitable protocol). These remote access technologies may be implemented in connection with the remote computers 2074.

It should be understood that the various technologies described herein may be implemented in connection with hardware, software or a combination of both. Thus, various technologies, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the various technologies. In the case of program code execution on programmable computers, the computing device may include a processor, a storage medium readable by the processor (including volatile and non-volatile memory and/or storage elements), at least one input device, and at least one output device. One or more programs that may implement or utilize the various technologies described herein may use an application programming interface (API), reusable controls, and the like. Such programs may be implemented in a high level procedural or object-oriented programming language to communicate with a computer system. However, the program(s) may be implemented in assembly or machine language, if desired. In any case, the language may be a compiled or interpreted language, and combined with hardware implementations. Also, the program code may execute entirely on a user's computing device, on the user's computing device, as a stand-alone software package, on the user's computer and on a remote computer or entirely on the remote computer or a server computer.

Those with skill in the art will appreciate that any of the listed architectures, features or standards discussed above with respect to the example computing system 2000 may be omitted for use with a computing system used in accordance with the various embodiments disclosed herein because technology and standards continue to evolve over time.

While the foregoing is directed to implementations of various technologies described herein, other and further implementations may be devised without departing from the basic scope thereof. Although the subject matter has been described in language specific to structural features and/or methodological acts, it is to be understood that the subject matter defined in the appended claims is not limited to the specific features or acts described above. Rather, the specific features and acts described above are disclosed as example forms of implementing the claims.

What is claimed is:

1. A method for performing an assessment using a competency management system, comprising:
displaying a skills map for a position within an organization, wherein the skills map corresponds to at least one skill represented by one or more skill units, and wherein each skill unit comprises one or more skill elements having one or more evidence requirements and one or more competency levels;
receiving self-assessment data corresponding to the one or more evidence requirements of the one or more skill elements, wherein the self-assessment data comprises one or more augmented reality simulations recorded using the competency management system and an augmented reality device;
determining a self-assessment competency score based on the self-assessment data;
receiving supervisor assessment data from a supervisor of the organization, wherein the supervisor assessment data comprises data indicating a confirmation or denial of the self-assessment competency score based on a review of the one or more augmented reality simulations; and
determining a supervisor assessment competency score based on the supervisor assessment data.

2. The method of claim 1, wherein the self-assessment data comprise one or more narrative answers, and wherein the supervisor assessment data further comprise data indicating a confirmation or denial of the self-assessment competency score based on a comparison of the one or more narrative answers to one or more predetermined narrative answers.

3. The method of claim 2, wherein the one or more narratives answers comprise definitions of terms, a listing of factors, identification of issues, discussions of topics, or combinations thereof.

4. The method of claim 1, further comprising determining one or more training options if the supervisor assessment competency score is less than a target competency score.

5. The method of claim 1, further comprising:
transmitting the self-assessment data, the supervisor assessment data, and the skills map to a verifier if the supervisor assessment competency score is greater than or equal to a target competency score for a predetermined competency level;
receiving verifier assessment data from the verifier, wherein the verifier assessment data comprises data indicating a confirmation of the supervisor assessment competency score based on a review of the self-assessment data and the supervisor assessment data; and
based on the verifier assessment data, designating the supervisor assessment competency score as a final competency score.

6. The method of claim 1, wherein the displayed skills map includes one or more hyperlinks used to display the at least one skill, the one or more skill units, the one or more skill elements, the one or more evidence requirements, and the one or more competency levels.

7. The method of claim 1, wherein:
the one or more skill elements describe one or more tasks to be performed in order to demonstrate the one or more competency levels for the at least one skill;
the one or more augmented reality simulations comprise simulations of the one or more tasks; and
the one or more augmented reality simulations are used by the supervisor to confirm or deny that an organizational member of the organization is capable of performing the one or more tasks described in the one or more skill elements.

8. The method of claim 1, wherein the self-assessment competency score and the supervisor assessment competency score are determined based on weighting data for the one or more skill elements.

9. A method for performing a report authentication module of a competency management system, comprising:
receiving assessment data corresponding to one or more skills for one or more members of an organization;
receiving a request to generate a report based on the assessment data, wherein the report comprises a summary of the assessment data;
generating a Quick Response (QR) code for the report; and
generating the report with the QR code displayed therein.

10. The method of claim 9, wherein the QR code is configured to verify a validity of the competency assessment data within the report via scanning of the QR code.

11. The method of claim 9, wherein the assessment data comprises self-assessment data, a self-assessment competency score, supervisor assessment data, a supervisor assessment competency score, the verifier assessment data, or combinations thereof corresponding to the one or more skills for the one or more members.

12. The method of claim 11, wherein receiving the assessment data comprises:
receiving the self-assessment data for one or more skill elements of the one or more skills, wherein the self-assessment data comprises evidence corresponding to one or more evidence requirements of the one or more skill elements for one or more competency levels;
determining the self-assessment competency score based on the self-assessment data;
receiving the supervisor assessment data from a supervisor of the organization, wherein the supervisor assessment data comprises data indicating a confirmation or denial of the self-assessment competency score based on the one or more evidence requirements; and
determining the supervisor assessment competency score based on the supervisor assessment data.

13. The method of claim 12, further comprising:
transmitting the self-assessment data and the supervisor assessment data to a verifier if the supervisor assessment competency score is greater than or equal to a target competency score;
receiving the verifier assessment data from the verifier, wherein the verifier assessment data comprises data indicating a confirmation or denial of the supervisor assessment competency score based on a review of the self-assessment data and the supervisor assessment data; and
based on the verifier assessment data, designating the supervisor assessment competency score as the final competency score.

14. The method of claim 13, further comprising determining one or more training options if the supervisor assessment competency score is less than the target competency score.

15. The method of claim 12, wherein the displayed skills map includes one or more hyperlinks used to display the at least one skill, the one or more skill units, the one or more skill elements, the one or more evidence requirements, and the one or more competency levels.

16. The method of claim 12, wherein the one or more skill elements describe tasks to be performed or information to be provided in order to demonstrate the one or more competency levels for the at least one skill.

17. A method for performing a social media module for a competency management system, comprising:
identifying a member of an organization having a competency score for a skill used by the member that corresponds to a competency level of a plurality of competency levels, wherein the competency score is greater than or equal to a predetermined competency score;
accessing a social media account using a network; and
communicating an endorsement of the member with respect to the skill using the social media account.

18. The method of claim 17, wherein the social media account comprises a social media account of the organization or a social media account of a supervisor of the organization who determined a supervisor assessment competency score for the skill for the member at the competency level.

19. The method of claim 17, wherein the endorsement of the member comprises an endorsement from a supervisor of the organization who determined a supervisor assessment competency score for the skill for the member at the competency level.

20. The method of claim 17, wherein the endorsement of the member comprises an endorsement from the organization.
